(19) United States
(12) Patent Application Publication
(10) Pub. No.: US 2020/0286161 A1
(43) Pub. Date: Sep. 10, 2020

(54) SERVICE PROVIDER SYSTEM AND METHOD

(71) Applicant: Diego Marguello, San Francisco, CA (US)

(72) Inventor: Diego Marguello, San Francisco, CA (US)

(21) Appl. No.: 16/794,049

(22) PCT Filed: Aug. 20, 2018
(86) PCT No.: PCT/IB2018/001199

§ 371 Date: Feb. 18, 2020

Related U.S. Application Data
(60) Provisional application No. 62/547,725, filed on Aug. 18, 2017.

(51) Int. Cl. G06Q 30/06; H04N 21/254; H04N 21/478; G06F 3/0482; G06T 19/00

(52) U.S. Cl. CPC G06Q 30/0643; G06Q 30/0611; G06Q 30/0639; G06T 19/006; H04N 21/47815; G06F 3/0482; H04N 21/2542

(57) ABSTRACT

A system allows buyers and service providers in different worldwide locations to connect and communicate through a computer network in communication with a server and client computing devices. The service providers can transmit life video feeds to the buyers in order to receive services such as purchasing of goods. The service provider can transmit the goods to the buyer and electronic funds transfers can be provided from the buyer account to the server and service provider's electronic account.

### CROSS REFERENCE TO RELATED APPLICATIONS

This application claims priority to U.S. Provisional Patent Application No. 62/547,725, “Service Provider System And Method” filed Aug. 18, 2017 which is hereby incorporated by reference in its entirety.

### BACKGROUND

A personal shopper is a person who helps others shop by giving advice and making suggestions. They are often employed by department stores and boutiques, although some are freelance or work exclusively online. Their focus is usually on clothes, although the number of non-clothing stores such as furniture retailers offer personal shopping services is on the rise. A personal shopper is typically employed by the store itself, which means that payment for the service is not required. Other stores will charge a small fee to use their personal shoppers and the amenities that come along with the service. Personal shoppers can also be known as fashion stylists, shop assistants, or sales assistants. Some personal shoppers operate without affiliation on a freelance basis, including private client event styling and closet organizing.

Online shopping is a form of electronic commerce which allows consumers to directly buy goods or services from a seller over the Internet using a web browser. Consumers find a product of interest by visiting the website of the retailer directly or by searching among alternative vendors using a shopping search engine, which displays the same product's availability and pricing at different e-retailers.

What is needed is a system that will combine online and personal services such as personal shopping and other services so that system users can interact directly with a personal service provider who can perform on line tasks such as shopping.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a screen shot of a buyer user interface (UI) showing a plurality of cities where service providers are located.

FIG. 2 illustrates a screen shot of a buyer UI showing Paris as a city selected by a buyer.

FIG. 3 illustrates a screen shot of a buyer UI showing a plurality of personal shoppers in Paris.

FIG. 4 illustrates a screen shot of a buyer UI showing a personal shopper profile.

FIG. 5 illustrates a screen shot of a buyer UI showing a personal shopper live feed.

FIG. 6 illustrates a screen shot of a buyer page UI showing profile and personal shopper information.

FIG. 7 illustrates screen shot of a a buyer UI page showing personal shopper information.

FIG. 8 illustrates a screen shot of a purchase request input UI page.

FIG. 9 illustrates a screen shot of a buyer UI page showing buyer product request listing.

FIGS. 10 and 11 illustrate screen shots of augmented reality (AR) chat UI pages.

FIG. 12 illustrates a screen shot of a text chat UI page.

FIG. 13 illustrates a screen shot of a map based text chat UI page.

FIGS. 14-16 illustrate screen shots of AR Chat facial recognition UI pages.

FIGS. 17-19 illustrate screen shots of AR location identification and information UI pages.

FIG. 20 illustrates a screen shot of an AR system user chat and information UI page.

FIG. 21 illustrates a screen shot of an AR system user search and information UI page.

FIG. 22 illustrates a screen shot of a product details input UI page.

FIG. 23 illustrates a screen shot of a product price check UI page.

FIGS. 24-25 illustrate screen shots of product visual recognition UI pages.

FIG. 26 illustrates a screen shot of a UI page showing personal shopper status and locations.

FIG. 27 illustrates a screen shot of a UI page showing retail business offers transmitter to a buyer.

FIG. 28 illustrates a screen shot of a UI social media page showing a listing of people of the user is following and posted photos.

FIG. 29 illustrates a screen shot of a life feed for a personal shopper with UI buttons.

FIG. 30 illustrates a screen shot of a UI for adding money to a user's account.

FIG. 31 illustrates a screen shot of a UI for sharing activity information with friends.

FIGS. 32-38 illustrate screen shots of a life feed for a personal shopper with UI buttons.

FIG. 39 illustrates a screen shot of a UI for selecting personal shoppers.

FIG. 40 illustrates a screen shot of a UI with multiple life feeds from personal shoppers with control buttons.

FIG. 41 illustrates a screen shot of a UI with phone call feature.

FIG. 42 illustrates a screen shot of a UI for uploading a product image.

FIGS. 43-46 illustrate screen shots of UIs for a location map with user images indicating system user locations.

FIG. 47 illustrates a screen shot of a user accounting information UI.

FIG. 48 illustrates a screen shot of a user purchase information UI.

FIG. 49 illustrates a screen shot of a pending shipment page UI.

FIG. 50 illustrates a screen shot of an user mode selection page UI.

FIG. 51 illustrates a screen shot of an service provider price and service input page UI.

FIG. 52 illustrates a screen shot of service provider and service page UI.

FIG. 53 illustrates a screen shot of service provider's news feed page UI.

FIG. 54 illustrates a screen shot of service provider's live feed UI.

FIG. 55 illustrates an embodiment of a personal shopper UI with multiple buyers.

FIG. 56 illustrates an embodiment of a change city UI for buyers.

FIG. 57 illustrates a UI for buyers listing service providers in the buyer selected location.

FIG. 58 illustrates a UI with live feeds from multiple service providers.

FIG. 59 illustrates a UI with deals from multiple vendors and service providers.

FIG. 60 illustrates a trending page for different regions within a selected locations.

FIG. 61 illustrates an additional information directory page for different regions within a selected locations.

FIG. 62 illustrates an embodiment of a buyer flow chart.

FIG. 63 illustrates an embodiment of a service provider flow chart.

FIG. 64 illustrates diagram of a computer system including a server and client computing devices.

### DETAILED DESCRIPTION

In an embodiment, the system can include a plurality of client computing devices such as computers or smart phones and one or more servers which can communicate through the Internet. Each system user may have to provide identification information which is stored on a system server. This process can be formed through a log in screen shot on a mobile device. For example, a user can enter a user name and a password to log into the virtual personal shopping system. Alternatively, the user can perform the login through social media such as LinkedIn, or Facebook. The user must click on the “agree to terms and conditions” box and click on the login button. If the user has not setup a login for the system, this can be done by clicking on the “signup button”. If the user has forgotten the password, the “forgot password” button can be clicked. Computer software can be downloaded to the computing devices of the system users so that system users can communicate and store data on a database coupled to a server computer. The data base can store user information, purchase information, account information, rating information, etc.

Once the user has downloaded the system software and logged in, the user can interact with the system. The system can first ask the user if he or she would like to be a service provider or a service buyer. The user can respond by clicking on the service provider button or the service buyer button on a user interface. A personal shopper will buy goods for a buyer and a buyer will use a personal shopper to buy goods.

If the user clicks on the service buyer button, the system can display the options of “Go live” or go to news feed. The user can click on the Go Live button to be connected with a service buyer. Alternatively, the user can click on the go to news feed button which can result in the user interface displaying a listing of service buyers and locations of service buyers.

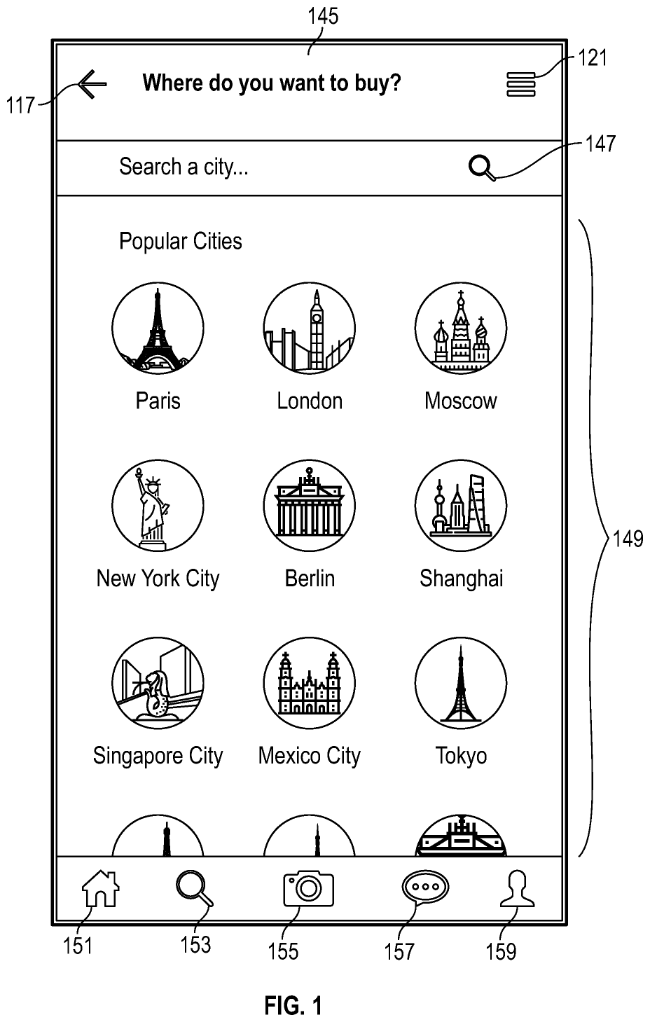

If the user is a service buyer, the system user interface (UI) on the user's computing device can communicate with a system server and display a list of cities for shopping. With reference to FIG. 1, the listing of cities can include: Paris, London, Moscow, New York, Berlin, Shanghai, Singapore, Mexico City, Tokyo, etc. The user can click on any of the displayed city buttons 149 or input a name into the search a city input 147. The UI page 145 can have a back button 117 and a menu button 121. The user can input a city and click a search button 147 to search the system for users in the input city. The UI page 145 can also include a home button 151, a search button 153, a camera button 155, a messaging button 157 and a personal profile button 159.

When the user clicks on a city or inputs a city, the system can identify and display all shoppers in the selected city. If a user selects a city that does not have any shoppers available, the system can display a message indicating that no personal shoppers in the selected city. In an embodiment, the user may have the option of being notified when a shopper is available in the desired city. The user can click on the OK button to return to the previous city selection screen. In an embodiment, the system can display a listing of languages that the service buyer can communicate in. The system user can input the known languages and the system can respond by only displaying and connecting buyers and sellers who can communicate in a common language.

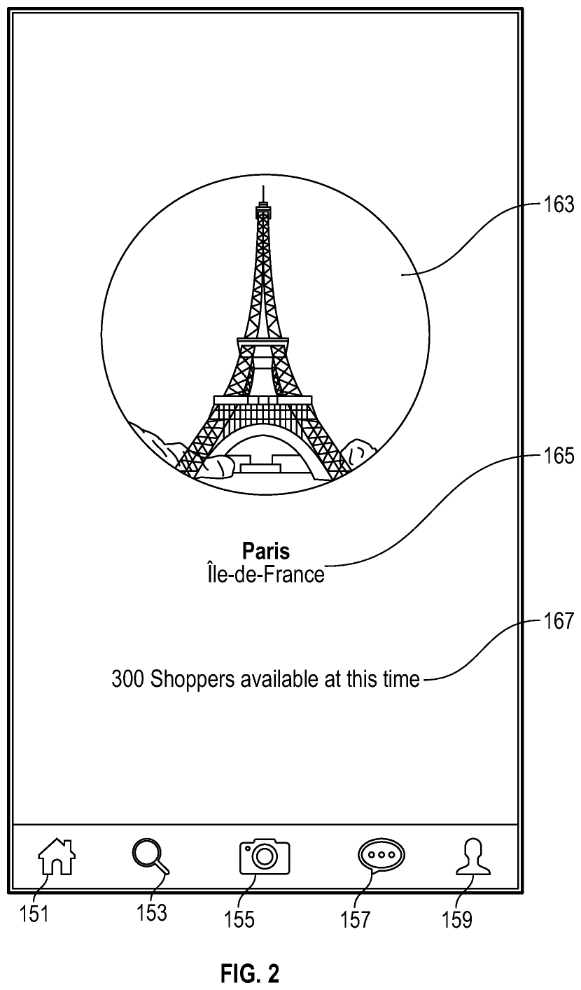

In an example shown in FIG. 2, a user has selected Paris. The UI can display Paris as the selected city 165 and a photo of Paris 163. The system UI has identified 300 personal shoppers 167 who are available who also communicate in English. The user can click on the shopper's button 167 to display more information for each of the filtered personal service providers in Paris.

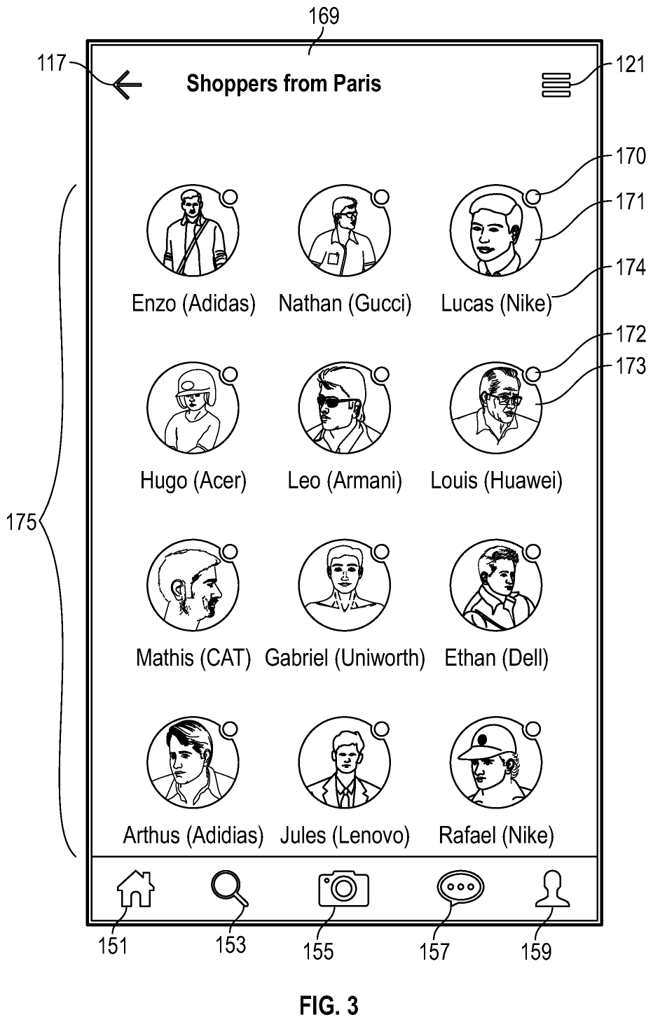

With reference to FIG. 3, the system UI can display a listing of shoppers currently in Paris. The listing of shoppers can include a photo of the shopper 171, a name and a store location of the shopper 174 and a status indicator 170, 172. The status indicator 172 in this example, can be a small circle green if the shopper is live and available and red 170 if the shopper is off line and not available. For example, the user interface of the user's smart phone can display several shoppers including: “Nathan” located at the Gucci store in Paris who the status indicator shows is available. In contrast, another shopper “Louis” in Paris is at the Huawei store but his status indicator shows that he is not available.

A user can click on any of the shoppers to select any of the listed shoppers. However, if the user selects a shopper who is not available, the system can display a message stating that the shopper that has been selected is offline. The user can then click on the select another shopper button to return the list of shopper page. If the user selects a shopper who is on-line, the system can display a message indicating that the shopper is on line and the user can click on the go live button to go the personal shoppers profile page.

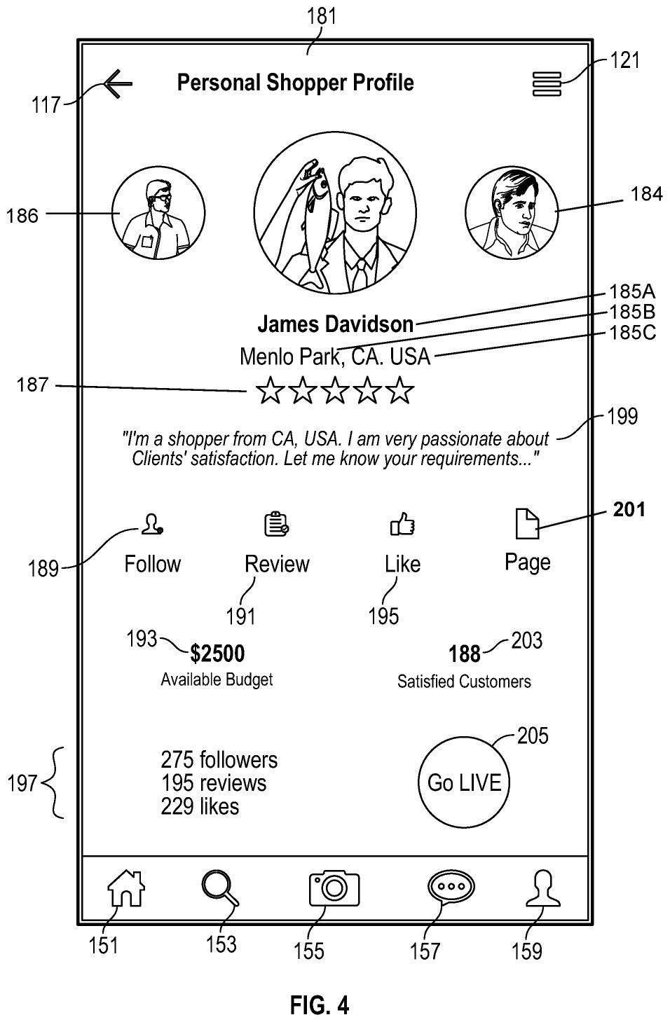

With reference to FIG. 4, a personal shopper profile page 181 is illustrated which can include the shopper's name, photo, city of residence, rating and a message 199. In this example, the shopper's name is James Davidson who lives in Menlo Park, Calif., USA. The shopper's page can also have a service rating from previous buyers. In this example, the shopper has a five star rating and has the message “I'm a shopper from CA, USA. I am very passionate about clients' satisfaction. Let me know your requirements . . . ” The shopper profile page 181 can also include buttons to follow this shopper 189, review the shopper 191, and like the shopper 195. The shopper profile page 181 can also display the buyer's available budget 193 and the number of satisfied customers 203. In this example, the buyer has a budget of $2,500 and the buyer has 188 satisfied customers. The shopper profile page 181 can also display additional information for the buyer such as followers, reviews and likes 197. If the buyer wants to use this buyer, the user can press the “go LIVE” button 205 which can result in direct communications between the service buyer and the service seller.

When the user uses the system, money can be stored in the system which can be used to by the service buyer to pay for the time and services of the service sellers and any goods that are purchased by the service seller for the service buyer. In some embodiments, the buyer may need a minimum level of funds in the system account to go live and interact with personal shoppers. This minimum level of funds can be related to the goods being purchased. For example, if the goods being purchased are a consumer electronics product such as a television set, the minimum level of funds can be $500. In contrast, if the buyer is purchasing a high-end designer suit the minimum level of funds can be $5,000 or more. In an embodiment, a database coupled to the processor can include a pricing database, which can include the range of prices for a wide variety of goods. If a user attempts to go live without the sufficient funds, the system can display a message requesting that the user recharge the account 207. The user can respond by clicking on the add money button 210 to add money to the account or clicking on the cancel button 208 to not add money to the account.

If the user wants to add money and clicks on the add money button and the system can display an add money page. The user can input financial account information, account name information and card number information. The financial information can be associated with bank accounts, credit cards, or other financial funds. Once the financial information has been input, the user can input the desired amount of money to transfer to the system funds and the user can click on the confirm and pay button. The system can confirm that the payment to the buyer's account has been processed and the funds can be visible through the user interface or inform the buyer that there was a problem and provide instructions for correcting the errors.

When the user clicks on the go live button and the user has sufficient funds in the account, the selected buyer's page can be displayed. The personal shopper and the buyer can each have mobile computing devices which each include a camera and video display. The personal shopper can use the camera to record the in-store shopping experience. The camera can stream video to the buyer and be positioned in a store so that the goods being offered for purchase can be shown to the buyer. The camera can be a 360 camera, a video camera which, the buyer's mobile phone camera, etc.

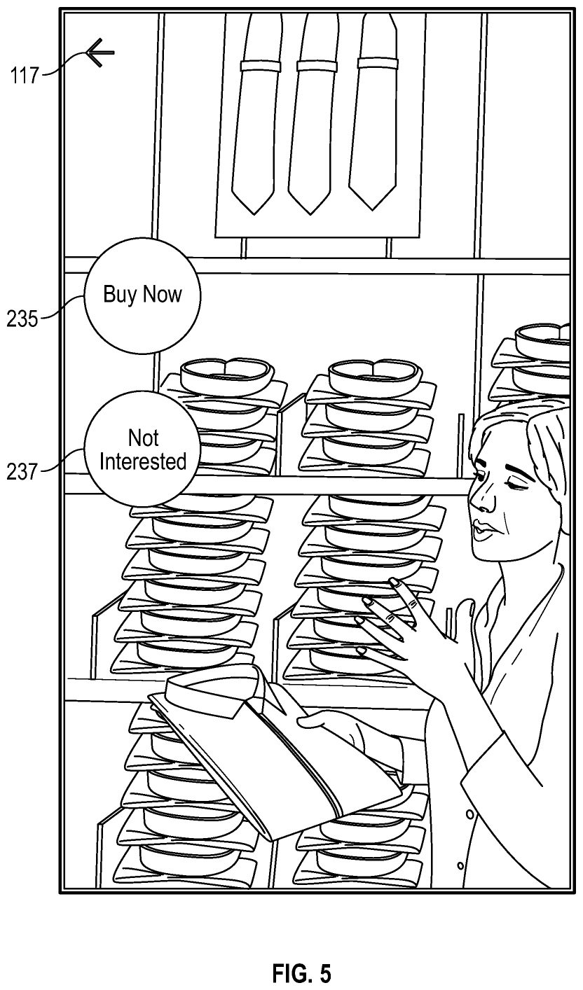

While video streaming, the personal shopper can interact with the buyer to identify goods that the buyer may be interested in purchasing. The user interface can display items can display that the buyer. With reference to FIG. 5, in the illustrated user interface, the buyer's mobile computer device is displaying video footage of the personal shopper selecting a shirt. The buyer can talk with the personal shopper through a microphone and speaker on the buyer's and personal shopper's mobile computing devices. The personal shopper can recommend purchases for the buyer and the user interface of the buyer's mobile computing device can display a buy now button 235 and a not interested button 237. If buyer clicks on the buy now button 235, the personal shopper will purchase the item and the funds for the purchase can be deducted from the buyer's account.

In an embodiment, the personal shopper can scan or photograph a bar code or a QR code on a hangtag on the product with a device coupled or integrated with the mobile computing device. The personal shopper's mobile computing device can transmit the product bar or QR code information to the system server which can be coupled to a database of product information. Based upon the bar or QR code, the server can search the database and obtain the stored product information from the database. This product information can then be transmitted from the server the buyer's computing device and displayed on the buyer's mobile computing device. This product information can help be useful for the buyer's purchase decision.

In an embodiment, the server coupled to a buyer information database that can include user information such as clothing size information for: shoes, shirts, pants, suits, etc. In addition to the size information, the stored user information can include personal preference, activity and style information such as: preferred colors, styles of clothing, etc. The personal shopper can review this buyer information so that the preferred goods can be obtained and the proper size of clothing can be purchased. The buyer's user interface can receive the video information from the personal shopper so that the buyer can see the goods. The user interface can then display a “buy now” button 235 and a “not interested” button 237. The user can press the “buy now” button 235 to confirm the purchase of the displayed goods by the personal shopper. Alternatively, the buyer can press the “not interested” button 237 to cancel the purchase of the displayed item.

If the item is purchased, the personal shopper can put the item into a cart and continue shopping. Once the buyer is done with shopping, the personal shopper can purchase the goods and ship the goods to the buyer. In an embodiment, the personal shopper may be required to pay for the goods from their account or with their own funding. The system can provide funding for the purchase, shipping and the personal shopper's service fee from the buyer's account once receipt of the goods is confirmed. The buyer can rate the personal shopper through the user interface. The account transaction, accounting, and the rating information can be stored on the server database.

If the system user decides to be a personal shopper, the user can click on a personal shopper button on the user interface. In an embodiment, the personal shopper may need sufficient funds to make purchases on behalf of the buyer. The system can determine if the user has sufficient funds to be a personal shopper. The funds required for the personal shopper can depend upon the goods being purchased. In different embodiments, the system can have minimum funds for personal shoppers that are a uniform value, such as $1,000. Alternatively, in other embodiments, the system can have different minimum funds for different types of goods and different numbers of simultaneous buyers. For example, a personal shopper budget for a single buyer of groceries can be $200 while a personal shopper for 5 or more buyers of luxury goods may require funds of several thousand dollars.

If the personal shopper does not have enough money in their account, the server can detect the error and transmitted a message to the buyer's computing device that the buyer does not have enough money and instructing the personal shopper to add funds to the budget. Once the personal shopper has added the required funds, the system can inform the user of the acceptance of the funds and the system can allow the user to access the personal shopper features of the inventive system.

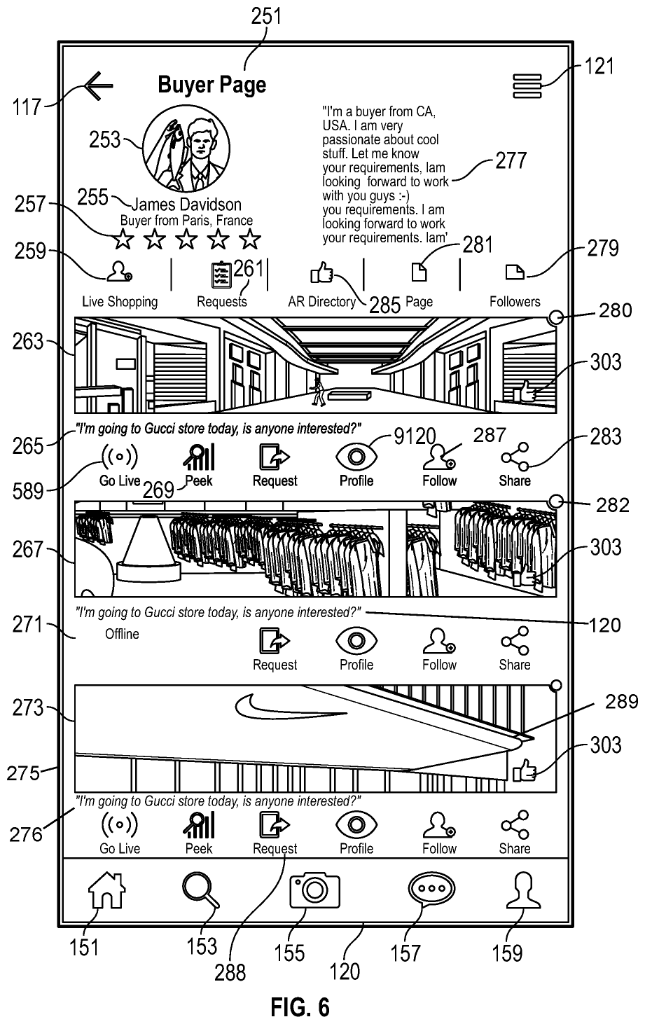

With reference to FIG. 6, in an embodiment of a buyer page 251 is illustrated which can include: buyer profile information, name and location city 255; buyer photo 253, buyer quote 277 which can be a brief description of themselves for the personal shoppers to read, A star rating 257 which can be from other system users based upon prior interaction reviews. The buyer page 251 can also include various controls including: Live Shopping 259, Buyer Requests 261, AR directory 285, Page 281, Followers 279. If the buyer clicks on the Live Shopping 259 button, the user interface enters the live shopping experience. The user is then prompted to select a city to shop in. If the user clicks on the requests button, the buyer user interface allows the user to create and view all requests the buyer or personal shopper has submitted. If the user clicks on the AR directory button 285, the user interface can provide a drop down arrow next to the word “AR directory”. User gets a drop down menu with augmented reality (AR) options and information. If the user clicks on the page button, the user interface is redirected to the main page that is the Principal Main page. If the user clicks on the followers button 279, the user interface is brought to the list of all those who the user is following and lists all followers of this particular user.

In an embodiment the buyer computing device can be used with a virtual reality (VR) system such as VR goggles, which includes orientation/directional sensors (accelerometers and gyroscopes) and a visual display. The VR goggles are coupled to the buyer's computing device. Examples of suitable VR goggles include Samsung Gear VR Goggles, VR ONE Virtual Reality Goggles and other Goggles, which can hold and convert a smart phone into a VR display. In this embodiment, the personal shopper may have a VR camera which can have a plurality of cameras arranged in a radial pattern on a spherical camera housing, such as the Samsung Gear 360, Vuze 3D 360 Spherical VR camera, Insta360, or other similar devices. The video information can be transmitted from the personal shopper-computing device to the buyer's VR goggles via a network such as the Internet and possibly through a system server so that the buyer can have a VR personal shopping experience. The visual display in the VR goggles will change in direction and orientation based upon the head movement of the buyer wearing the VR goggles. The buyer can look around in 360 degrees and the VR goggles may have a zoom in and zoom out feature so that the visual display can show details of the goods that the personal shopper is showing the buyer.

A listing of personal shoppers is listed on the buyer user interface page. In an embodiment each of the listed personal shoppers can include a photograph of the store location where the personal shopper is currently located 263 and a quote from the personal shopper 165. In this example, a personal shopper quote is “I'm going to Gucci store today, is anyone interested?” and another personal shopper quote is “I'm going to Nike store today, is anyone interested?” A buyer can respond to these messages by expressing an interest in a store that the personal shopper is going to. In an embodiment, the buyer can click “yes” interest and then receive an update when the personal shopper is at the store or an estimated time when the personal shopper is at the store. The buyer can receive the notification, which can be an alarm and in response to the alarm, the buyer can click on the go live button 267 when the personal shopper is at the store of interest to the buyer. In other embodiments, the user can set the user interface can automatically go live when the personal shopper is at the store of interest to the buyer based upon the GPS or other location tracking data for the personal shopper.

The buyer page user interface can include a personal shopper status indicator. The first personal shopper is active so a green light can be displayed. In contrast, the next lower personal shopper is not active so a red light is displayed and the Go Live and the Peek buttons are not available. The text “Offline” 271 is also displayed. The user can swipe up/down to view the other personal shoppers on the page.

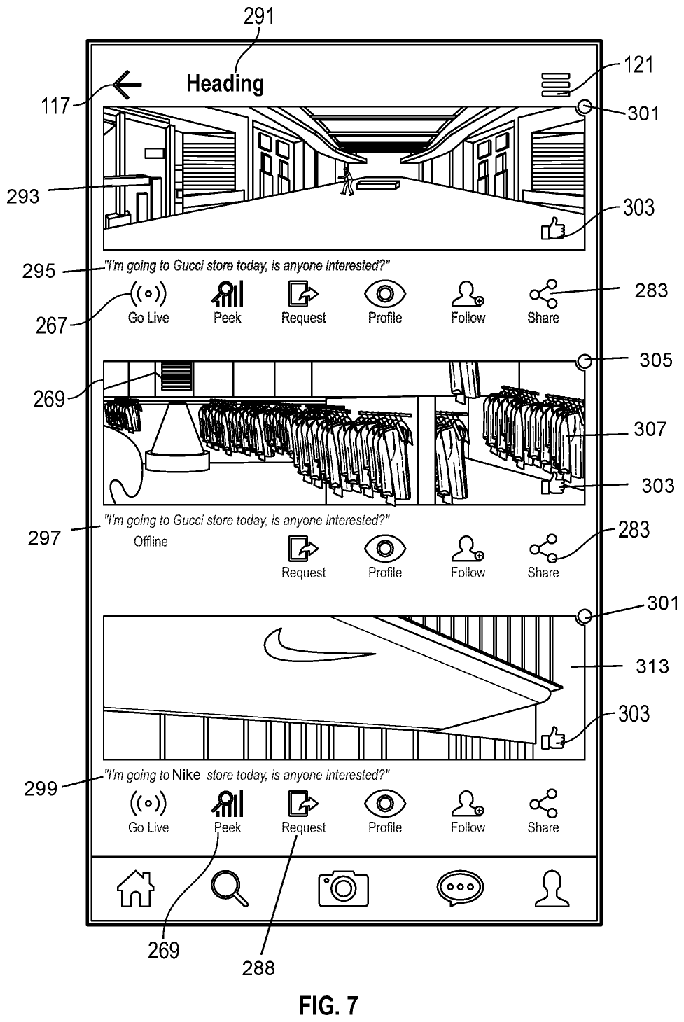

The personal shopper section can have a like button 303 which can be clicked by the buyer if the buyer likes the screen, image, personal shopper, location, information, etc. For each personal shopper there can be control buttons including go live 267, peek 269, request, profile, follow and share. When the personal shopper is active, the go live 267 and the peek buttons 269 can be displayed. The user can press the go live button 267 when the buyer wants to use and pay this personal shopper as described above. The user can press the peek button 269 which can allow the buyer to go to the site for free for a predetermined time period of 30 seconds or other duration of time to see what that personal shopper is doing. After the predetermined time has elapsed without the buyer pressing the go live button 589, the buyer's user interface is disconnected from the personal shopper. The buyer can either remain disconnected or if the go live button 589 is pressed, the buyer's user interface is connected to the personal shopper. In an embodiment, the system can disconnect the buyer if the buyer's account does not have sufficient funds to pay the price per minute rate of the personal shopper. This feature can prevent buyers who cannot pay for the personal shopping services from receiving live services from the personal shoppers. With reference to FIG. 7, the system UI can remove the buyer profile information from the UI page 291 so that the display of the computing device can just show store and control buttons as described above.

In an embodiment, the buyer user interface can include a request button which can be pressed so that the buyer can input a purchase request. The system UI can respond by displaying a request page. The user can be transmitted by text and/or voice messages. In an embodiment, the voice request can be converted into a text message. In some situations, the request can be converted from the native language of the buyer into the native language of the personal shopper. The personal shopper can receive the request and possibly confirm the request or respond if the request cannot be processed. For example, if the requested goods are not sold at the store location of the personal shopper, the personal shopper can respond by informing the buyer that the request cannot be processed.

In an embodiment, the user interface page 251 can include a personal shopper profile button 273 which can be pressed so that the buyer is able to read the profile of the personal shopper related to that image/location seen above. The user interface page 251 can include a share button 283 which can be pressed so that the buyer can share the information seen by the buyer with other users within the app. In an embodiment, the other buyers can communicate approval/disapproval of proposed goods.

In this example, the bottom of the user interface page 251 can include several application navigation buttons including: home key 151, search 153, camera 155, chat 157 and profile 159. The user can press the home key 151 to return to the UI home page. The user can click the search button 153 to search for specific text such as specific personal shoppers, goods, stores, etc. The user can click on the camera button 155 if the camera on the buyer's computing device is needed for photos or videos of the buyer or other images. The camera images can be transmitted from the buyer's computing device to the personal shopper or other users of the system. The user can click on the chat button 157 to chat with any other system user; the buyer can click on the profile button to view and update the user's profile. The chat button 157 can be used for text messaging with between the buyer and personal shopper or other system users. The profile button 159 can be used to view and edit the user's profile, which can be saved to the system server.

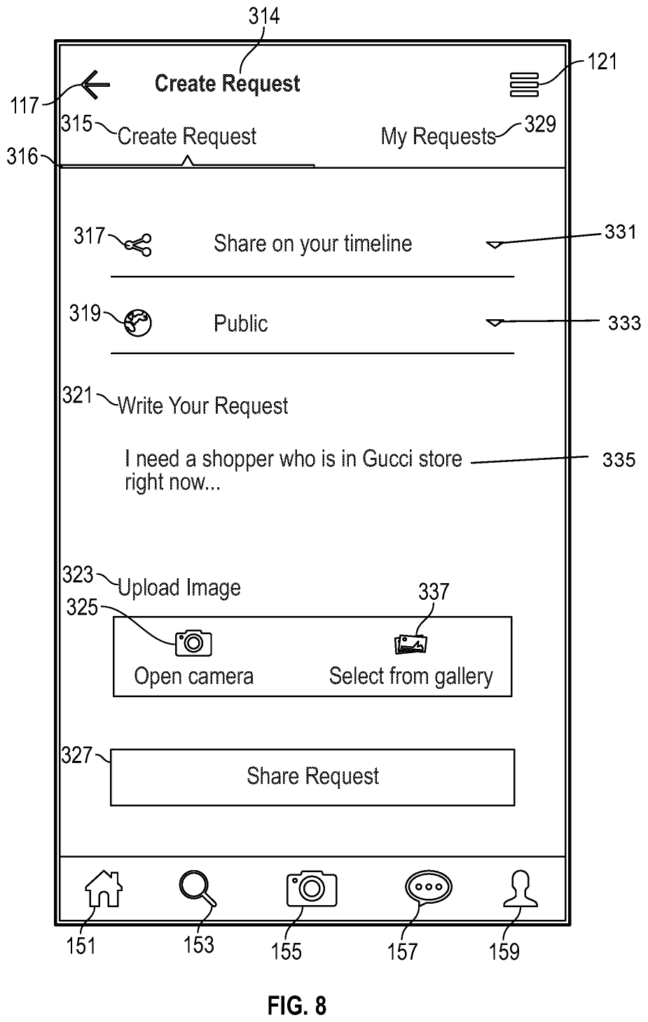

With reference to FIG. 8, the user has pressed the request button and the create request page 314 is displayed. The user interface displays “create request” 315 and “my requests” 329. In this example, the create request 315 is underlined with a green line 316. The text “Create Request” is also displayed on the upper portion of the display user interface. Thus, the user interface allows the user to create a request. The buyer has the option to share on your timeline 317 and/or public 319. If this share option is selected, the information requested is sent to other personal shoppers and can be displayed on the buyer's time line. If this public option is selected, the information requested is sent to the public and can be displayed on the buyer's time line.

The user inter face can include a section to input the buyers request 321. In this example, the user has typed, “I need a shopper who is in Gucci store right now . . . ” The user interface can also include an upload image button 323 to input a photo or video. The user can click on the open camera button 325 to use the mobile computing device's camera. Alternatively, the user can click on the select from gallery button 337 to upload a previously taken photo or video. Once the request is completed, the user can click on the share request 327 to transmit the request to the system and selected recipients or public.

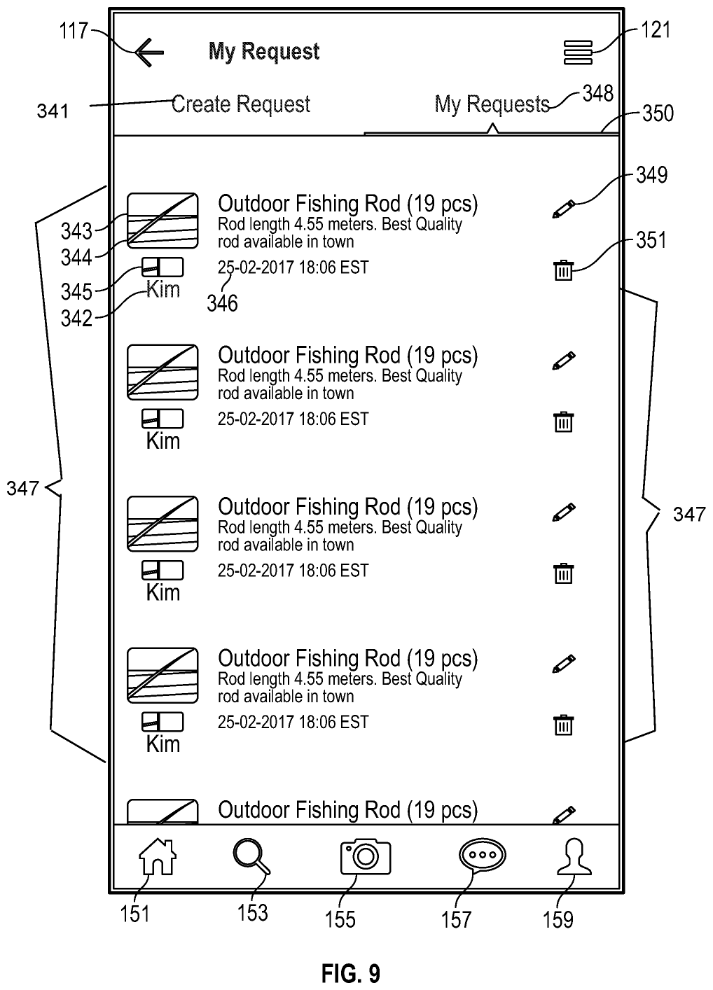

With reference to FIG. 9, the user can click on “my requests” 348 and the green line 350 can move to this text. The text “My Requests” is also displayed on the upper portion of the display user interface. The user interface can display all prior requests, which may be organized as a list. In this example, the first request description 344 is for 19 Outdoor Fishing Rods. The rod length of 4.55 meters and the best quality are requested. The buyer has also indicated that the fishing rod is available in town. A photo of the requested fishing rod 343 is displayed. The buyer can click on the pen button 349 to edit and make changes to the request or click on the garbage can icon 351 to delete the request. In an embodiment, the name 342 of the buyer making the request and the national flag 345 of the country where the item being requested is being purchased can be displayed. The time and date when the item was requested can also be displayed 346. In this example, all of the listed requests are identical. In other embodiments, each request will be different.

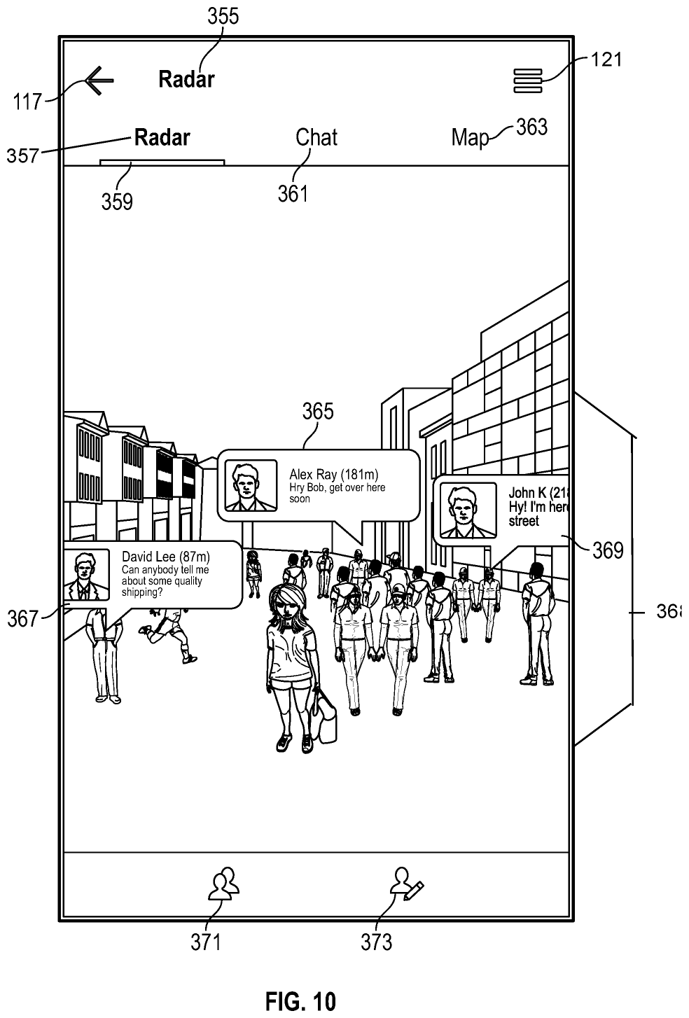

With reference to FIG. 10, the user has clicked on the augmented reality (AR) which results in an AR page 355. The AR page can include radar 359, chat 361 and map 363 buttons. In this example, the user has clicked on the radar 359 button, which can result in a street view of where the user and other friends are located. In this view, buyers and personal shoppers can be displayed to encourage users to connect and shop. In an embodiment, the augmented reality system can use the camera of the user's mobile computing device. In this example, the profile pictures and names and chat quotes displayed are all the friends the user. The profile information can be connected to and converse with in AR to the user. In this example, the user profile pictures and names and chat quotes are displayed for all the friends the user is connected to and converse with in AR who are in the video image. The AR system can over lay the information associated with system users who are visible on the camera. The system can use location information to determine the distance between the user and the AR display information for identified people in the image. The data layer level with closer user information is displayed over information for user's who are farther away. In this example, David Lee is 87 meters away and has posted the text, “Can anybody tell me about some quality shipping?” 367. Alex Ray is 181 meters away and has posted the message “Hay Bob, get over here soon” 365. If Bob is the user, he can be notified to meet Alex soon at the location specified by the system. John K is 218 meters away and has posted the message, “Hi! I'm here on the street” 369. At the bottom of the radar page, there a chat button 371 which is used to go to the chat page and a profile button 373 which can be used to edit and/or change the user's profile which can be displayed on the AR interface.

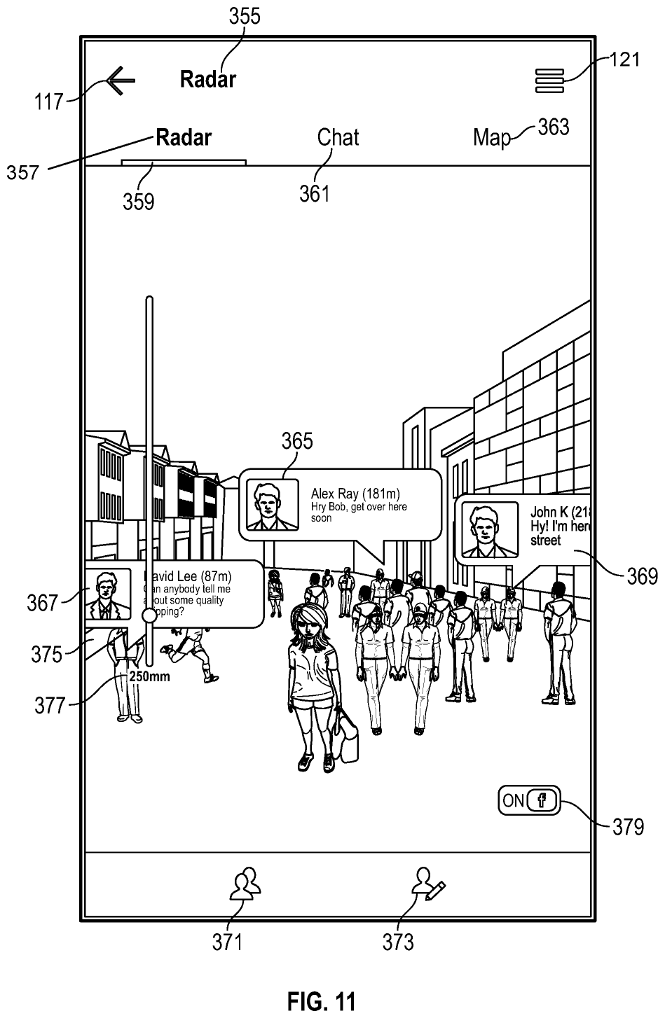

FIG. 11 illustrates an embodiment of the Radar view AR page 355, which includes a zoom slider control 375, which allows the user to zoom the illustrated image to alter the magnification of the displayed image. The user interface can display a zoom range 377. In this example, the zoom is 250 meters. A higher zoom will have a higher distance number. If a user is interested in a specific area, the zoom control can be used to narrow the focus of the camera and extend the range of view for the camera through a digital zoom lens. In an embodiment, the user interface can also include a social The AR system can over lay the information associated with system users who are visible on the camera. The system can use location information to determine the distance between the user and the AR display information for identified people in the image. The data layer level with closer user information is displayed over information for user's who are farther away. The social network button 379, which can allow user information to be uploaded to a social network system such as Facebook, LinkedIn, Instagram, Pintrest, Flickr, Myspace, Twitter, etc. In an embodiment, when the social network button 379, information from the shopping system for the user can be automatically posted.

In different embodiments, the system can be used with the described AR features which can be displayed as video data output to a display coupled to the user's mobile computing device. Alternatively, the AR displayed on to a visual display of the user's mobile computing device. Various technologies are used in augmented reality rendering. In an embodiment, the AR data is displayed on a head-mounted display (HMD) which can be worn on the forehead of a user. The HMD can place images of both the real world and virtual objects within the user's field of view. The HMD can include sensors for six degrees of freedom monitoring that allow the system to align virtual information to the physical world and adjust accordingly with the user's head movements.

In an embodiment, the AR display information can be rendered on special AR eyeglasses which can include both a camera(s) and a visual display in communication with a user's mobile computing device. The AR eyeglasses can include eyewear that employs cameras to intercept the real world view and re-display its augmented view through the eyepieces and devices in which the AR imagery is projected through or reflected off the surfaces of the eyewear's lenspieces. In an embodiment, AR data can be displayed on a head-up display (HUD) which is a transparent display that presents data without requiring users to look away from their usual viewpoints. Near-eye augmented reality devices can be used as portable head-up displays as they can show data, information, and images while the user views the real world. Many definitions of augmented reality only define it as overlaying the information. This is basically what a head-up display does; however, practically speaking, augmented reality is expected to include registration and tracking between the superimposed perceptions, sensations, information, data, and images and some portion of the real world.

In order to display the AR data, the user's computing device can analyze the sensed visual and other data to synthesize and position augmentations. The computer can then display the AR data as computer-generated images over the real world images viewed by the user. The Computer receives data from the sensors which determine the relative position of objects surface. This translates to an input to the computer which then outputs to the users by adding something that would otherwise not be there. The computer comprises memory and a processor. The computer takes the scanned environment and then generates images or a video and combines the computer generated information with the user's normal vision on the user's visual AR display for the user to see. The AR system can realistically integrate augmentations with the real world visual experience. The software can derive real world coordinates, independent from the camera, from camera images. That process is called image registration, and uses different methods of computer vision, mostly related to video tracking.

In an embodiment, the AR computer system can consist of two parts. The first stage is to detect the locations of persons, kiosks, buildings, and stores of interest in the AR device's camera images. This step can use feature detection methods like user GPS data or facial recognition data and building location map data. The second stage can restore real world coordinate system from the data obtained in the first stage. In an embodiment, the system can use Augmented Reality Markup Language (ARML) which is a data standard developed within the Open Geospatial Consortium (OGC), which consists of XML grammar to describe the location and appearance of virtual objects in the scene, as well as ECMAScript bindings to allow dynamic access to properties of virtual objects.

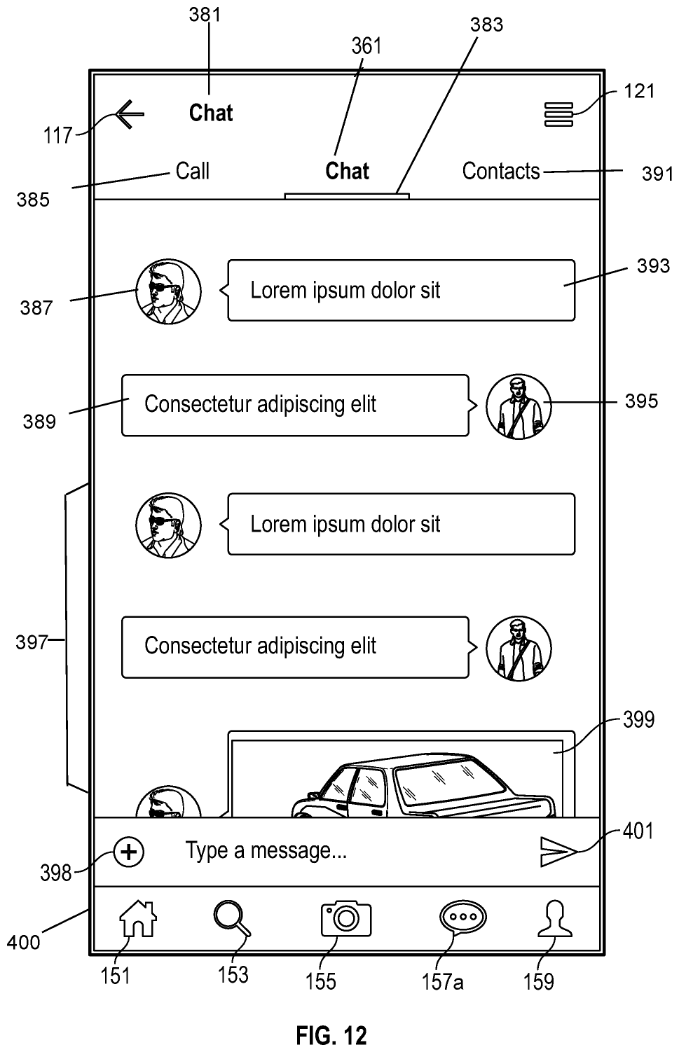

With reference to FIG. 12, the user interface displays a chat page. The user can select another user to chat with and use the text input area 398 to input text messages and then click the send arrow button 401. This can result in the text message being displayed at the top portion of the user interface with other previous messages. A photo of the person who posted the text can also be displayed so that each quote can be properly attributed. In addition to pure text, the user can also upload and post photos 399.

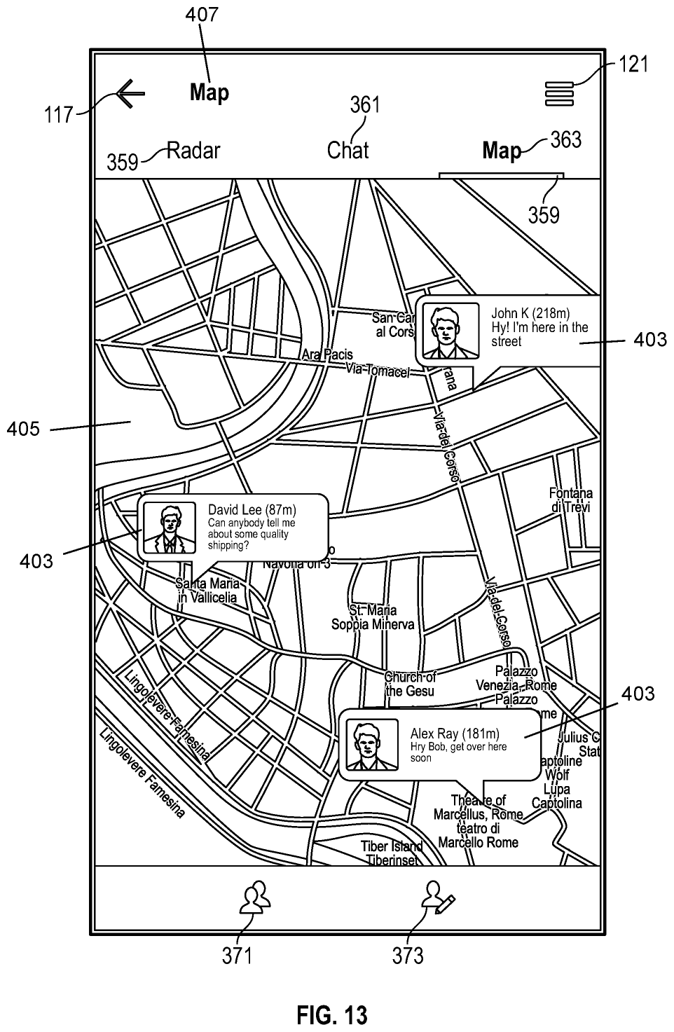

With reference to FIG. 13, the user has clicked on the map button 359, which is displayed at the top of the user interface. A map is displayed with streets, road names, points of interest and additional information being displayed. The system can obtain the global positioning system (GPS) data for each user and display the locations of each friend user at their GPS locations on the map. The user can use the location information to help with meeting or providing directions to a point of interest such as a desired retail-shopping store.

The user can click on the contacts button in the user interface and a listing of contacts page for system users (buyers and service providers) will be displayed. In an example, the contacts listed can include photos and names. The contacts can be listed in any sortable manner specified by the system user such as: alphabetical, most recently contacted, most frequently contacted, etc. By clicking on any of the photos or names, additional information for the user can be displayed.

The system user can create a user profile by clicking on a create user profile button which can result in the user interface displaying a profile input data page. The user can click on the update the stored image button. The user can then use the open camera button to take a new upload photos or click on the select from gallery to use an existing photo to upload. The interface can include a space to enter the user name, enter the user name and enter a phone number. The user interface can also include an enter description space which can allow the user to enter a description of user for the profile to be displayed on AR chats, buyer requests, shopping page, etc. Once the changes have been input through the user interface, the user can click on the update button to enter these changes.

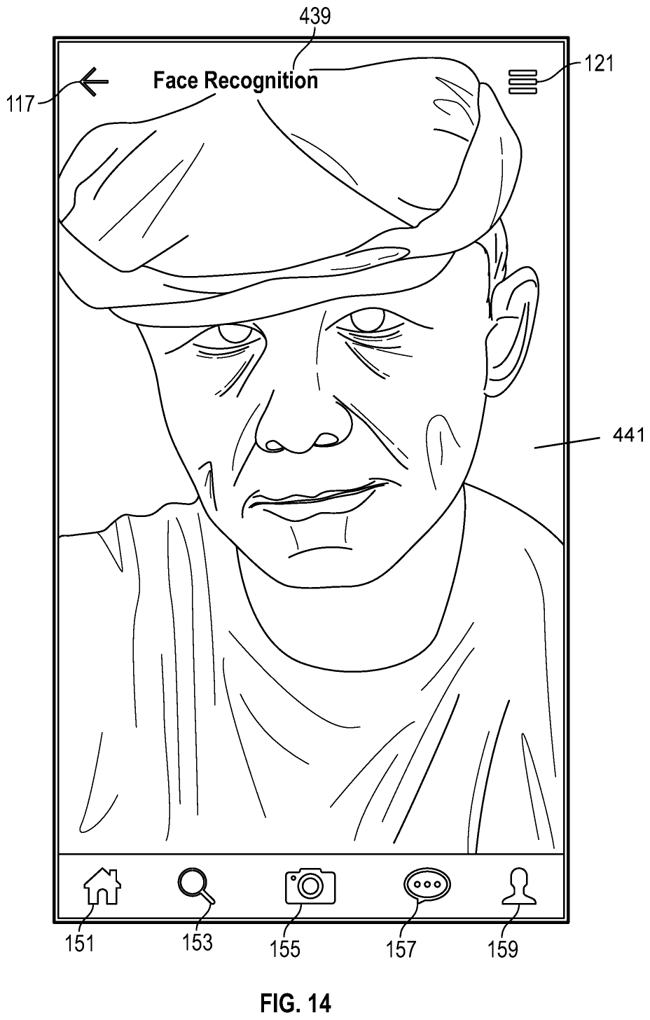

With reference to FIGS. 14 and 15, the system can include a face recognition user interface page 439. The user can take a picture of a friend using the camera button 155. The screen can display the photograph and the system can analyze the photograph so that the system can recognize any photos of the individual in other photos or video data. When the system recognizes a friend or system user, the system can associate the user information with the recognized user. In FIG. 15, the user can indicate an area of the photo for facial recognition. In this example, the user has indicated the lower portion, nose, mouth and jaw of the photo 445 for facial recognition. This reduced area may be necessary because the head is covered with a hat and the eyes are in the shadow of the hat. The user can input the photo to the system through the user interface and the system server can analyze the photo to see if the photo is of a registered user. The server can return a message indicated that the person in the photo is either a registered user or not a registered user who is recognized by the system user database.

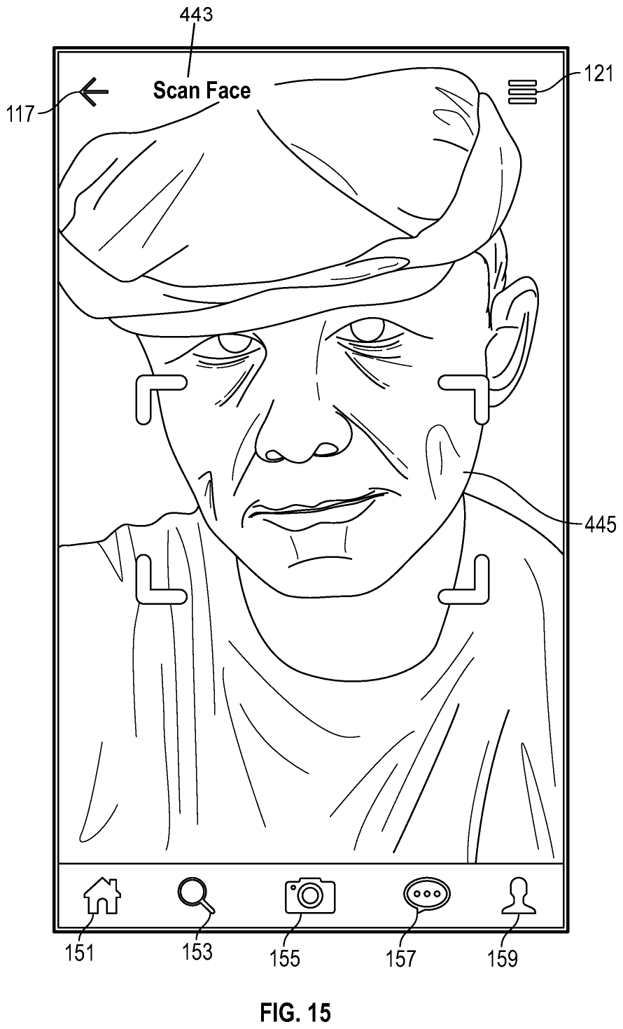

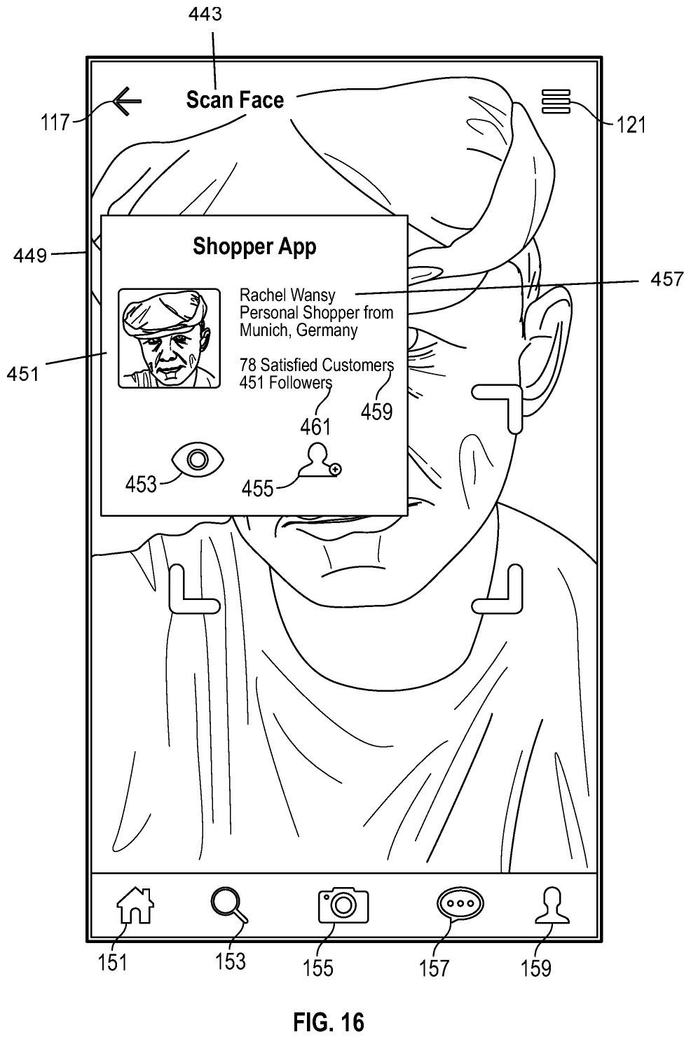

With reference to FIG. 16, the input photo is identified as a registered user who is recognized by the system user database. The system has responded to the recognized photo by displaying the full information of the scanned face from the system user database. The name of the person in database and city where the person can be displayed if a personal shopper or buyer or business profile in the photo has been identified. In this example, the name is Rachel Wansy who is a personal shopper from Munich, Germany. The system can also display additional information about the user such as the number of satisfied customers 459 and followers 461. The system can display an eye icon 453 which can be clicked for the user to become a follower of this personal shopper and a person+icon 455 which can be clicked to add the photographed person to user's contacts. The user can click on the follower button and the system asks the user to confirm or unfollow. The user can click the OK button to confirm the following of the personal shopper or click the unfollow button to cancel the follow instructions.

Optical Facial Recognition and Location Determination with a Handheld Device. Embodiments include a system that applies and processes optical facial recognition of tagged images can be generated by a handheld device and include at least one facial image and a location data. A processed result of the facial image and the location data are then used by a management system to identify the person and track the location of the person and possibly the person' status, such as service provider, buyer, etc. A handheld device may be used to generate a tagged image that may include an image of the indicator and a location associated with the object. A processor receives the tagged image and responds by performing a facial recognition process where features of the facial image are compared to a database of facial images. A facial recognition algorithm can be used to match the facial image to identify the corresponding system user. This database may be updated to identify the activity or status of the system user and provide location information. The described process can be performed by mobile device used in public settings to take the images of different system users. In contrast, when the user is taking a photograph of himself or herself, the system can can be the an operator identifier of the handheld device.

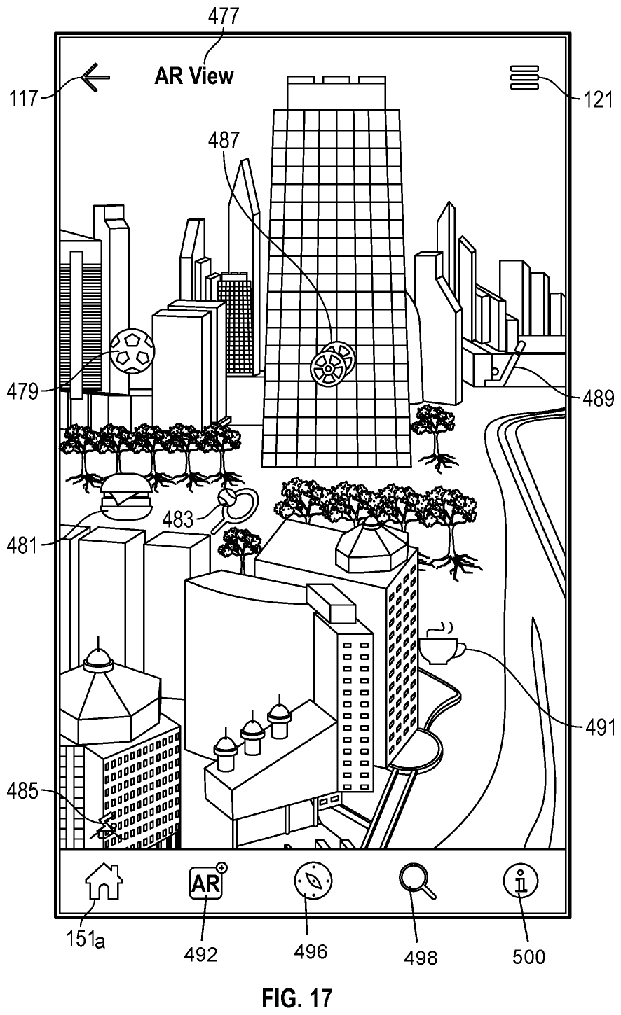

With reference to FIG. 17, an embodiment of an augmented reality (AR) view is illustrated. The user is viewing a city 477 through an AR View Camera on the mobile computing device. The AR view shows where Buyer/Shopper/Business/Chat/Contacts are located as well as the locations of businesses, food, coffee, sport events, etc. In this example, a soccer ball icon 479 can indicate the location of a soccer game, a hamburger icon 481 can indicate a location of a burger restaurant, a tennis racket icon 483 can indicate a tennis game/sporting goods store, a swimmer icon 485 can indicate the location of a swimming pool, a wheel icon 487 can indicate the location of a car dealership, a hockey stick icon 489 can indicate the location of a hockey game and a coffee cup icon 491 can indicate the location of a coffee shop.

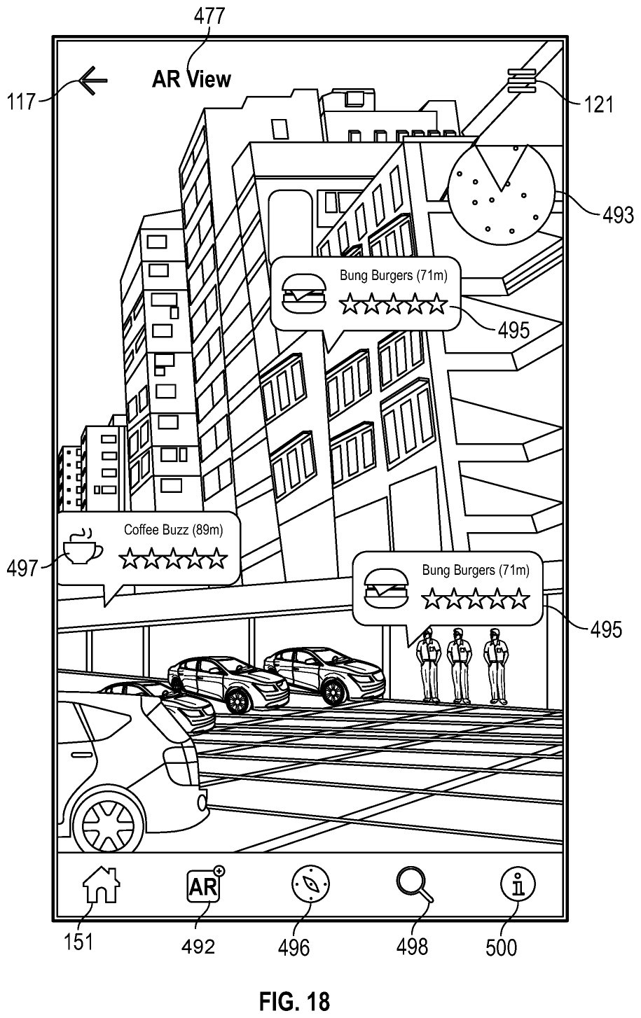

In an embodiment with reference to FIG. 18, the user can apply filters to the system so that only requested information is displayed. For example, if the user specifies that the system display food in AR view 477, the system can remove all icons other than the hamburger icon 495 and the coffee cup icon 497. The AR system can also display the name of the restaurant and the distance in meters from the user. The system can also display the restaurant rating from past customers.

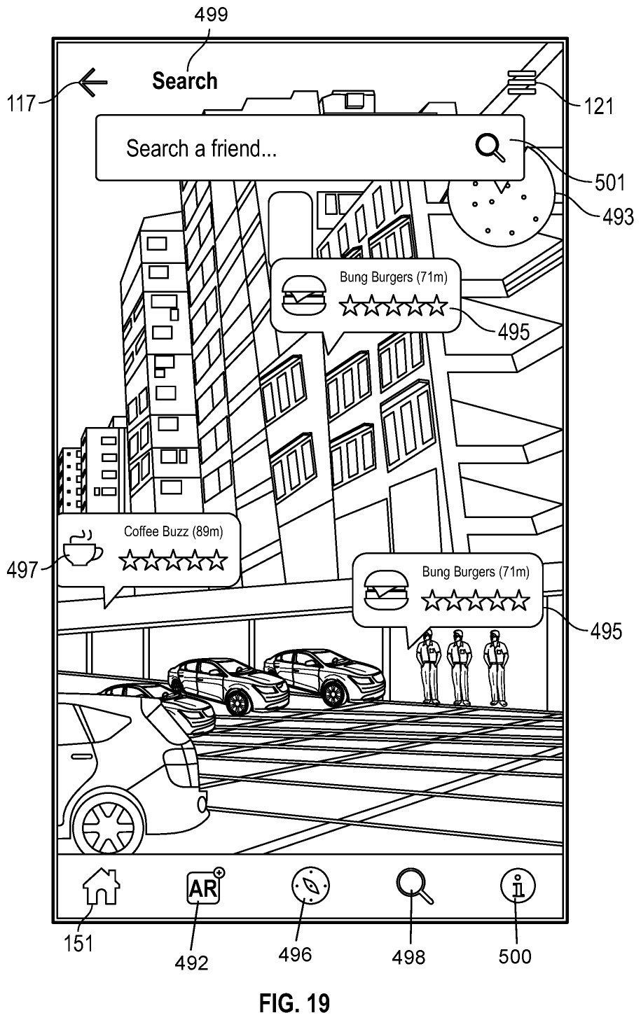

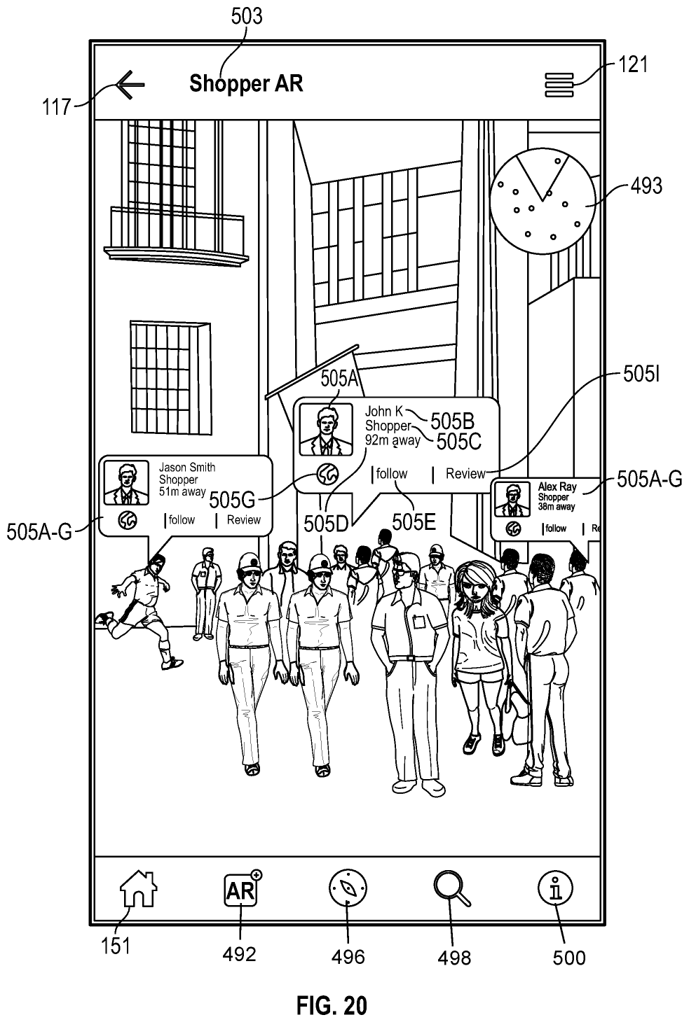

With reference to FIG. 19, the user interface can provide an input space 501 where the user can input a name of a friend. The user can click on the friend search button 501. The user can then type the name and the press the search button. With reference to FIG. 20, the AR interface can then display a photograph with friend information over the photographic image. In addition, the system can display a mini-map 493 of an AR View Camera shows where Buyers, Shoppers, Businesses, Chats, and other Contacts are located as well as businesses, food, coffee, sport events, etc. are located. The personal information overlay can include the photo 505A, name 505B, shopper or buyer identifier 505C, distance away 505D, follow button 505E and review button 505F. The UI can also provide a go live button 505G for each personal shopper. A buyer can click the go live button 505G to go live with the personal shopper. If the personal shopper is in close proximity, the user may actually meet the personal shopper.

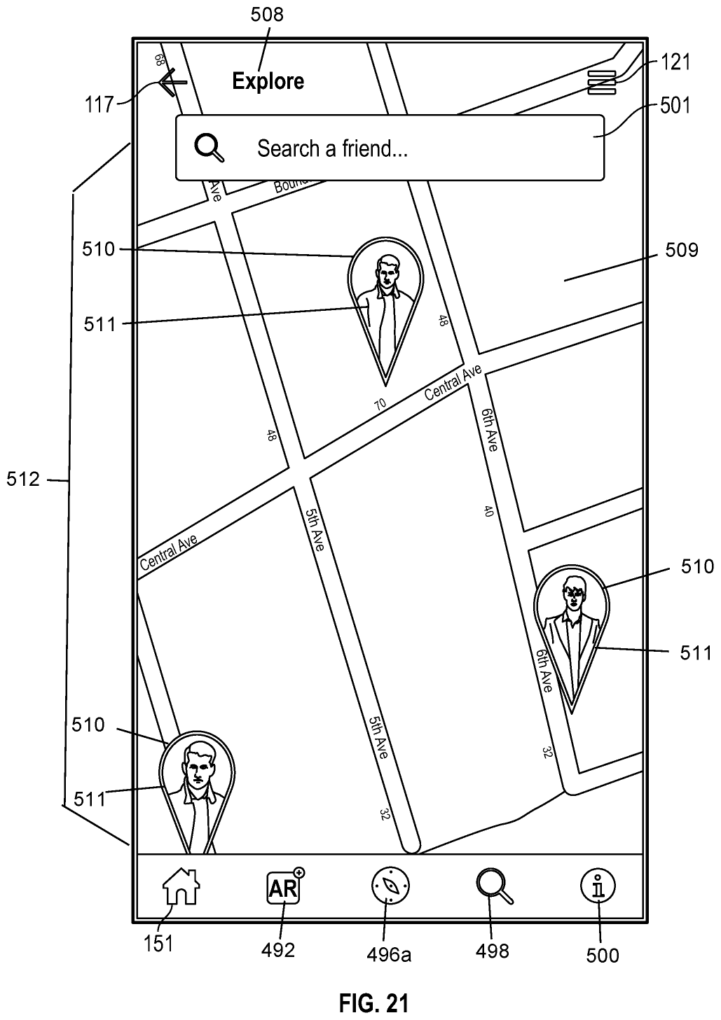

With reference to FIG. 21, the user has clicked on a map view button. The user has clicked on the map button. A map is displayed with streets, road names, points of interest and additional information being displayed. The system can obtain the GPS data for personal shoppers and display the locations and photos of each personal shoppers based upon their GPS locations on the map. The system can indicate the on-line and off-line status of each personal shopper. In the illustrated example, a green line surrounds the photos of the personal shoppers that are live and available and a red line surrounds the personal shoppers that are not available. In this example, the photos are inverted teardrop shaped with the lower tip of the photo pointing at the personal shopper's map location. When the user clicks on the menu button, the UI displays a menu of actions which include: upload, browse, how to use, change password and logout.

If the upload button is clicked, the system will provide instruction for uploading images for the AR features. The system can inform the user to Upload Texture you can only upload in JPG format. File size must be less than 2 MB. The user can click on the open camera button or the select from gallery button. Once the camera or gallery has been selected, the user can click on next button.

In an embodiment the system can display a UI upload page, the system can allow users to up load an image or a video or 3D models. The UI allows the user to upload an image or video, or use the camera to take photos, select stored images or videos from the camera's gallery memory, upload 3D model and select 3D model to upload. The user has selected the data to upload and the user can click on the upload button.

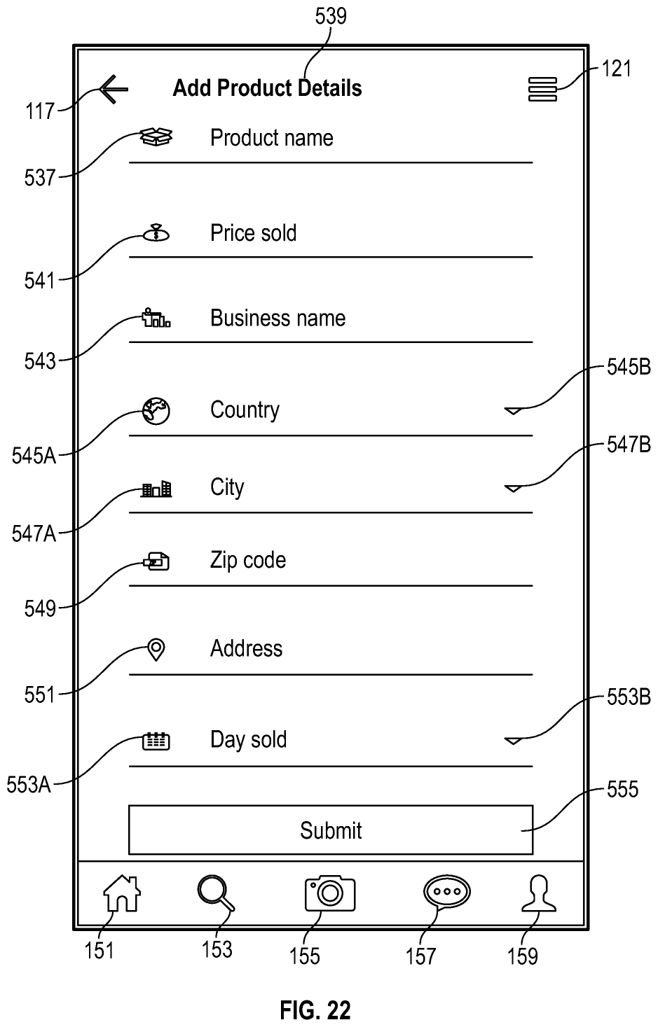

With reference to FIG. 22, the UI can include an add product details page 539 that includes various input fields. The user can input the product detail information and this information can be stored on the system's products database. If a user requests product information, the system can retrieve the stored data and provide it upon request. In this example, the product details includes: product name 537, price sold 541, business name 543 of the store that sells the product, country 545A which can have a pull down menu of countries 545B, city 547A which can have a pull down menu of cities 547B, zip code 549, address 551 and day sold 553A which can have a pull down calendar 555. In other embodiments, the add product information page 539 can include other product information such as: available colors, sizes, sizing errors if the product size labels are inaccurate, product options, etc. When this additional information has been input, the user can click the submit button and this data can be transmitted to the product database coupled to the system server.

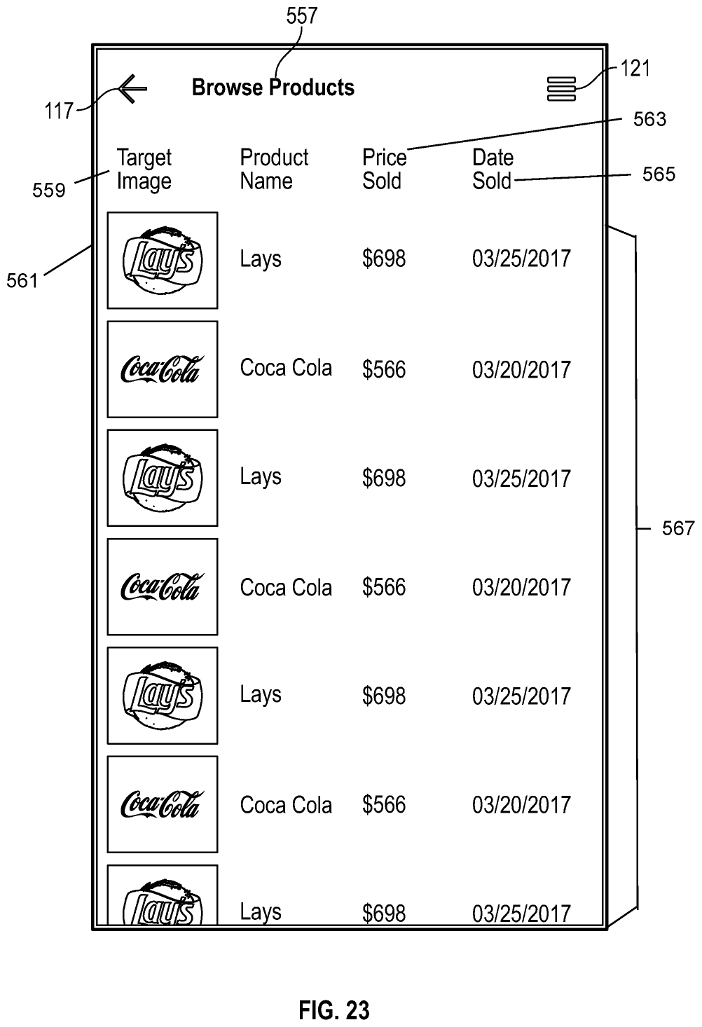

With reference to FIG. 23, the system can also store price information for goods on the product database coupled to the system server. In the illustrated example, the product image, product name, price sold and date sold are listed for various goods. The buyer can access the browse product page 557 and view all price information for goods recently purchased. In an embodiment, the system can also include: store of purchase, store location, sales, coupons used, and other purchase information for the goods. By reviewing this information, the buyer can determine if the offered price is reasonable based upon the price history.

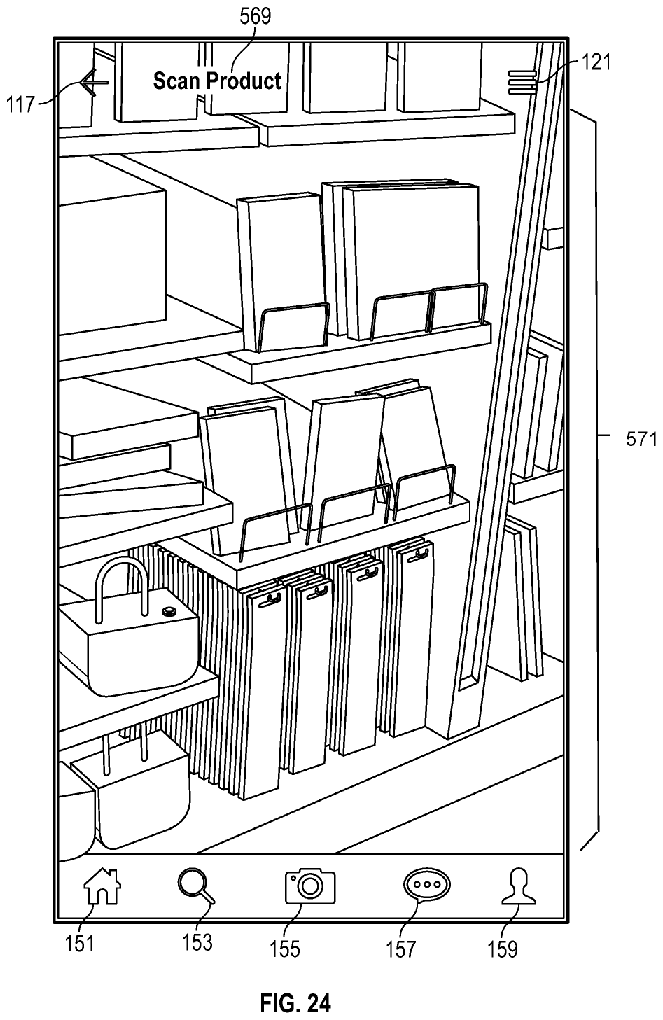

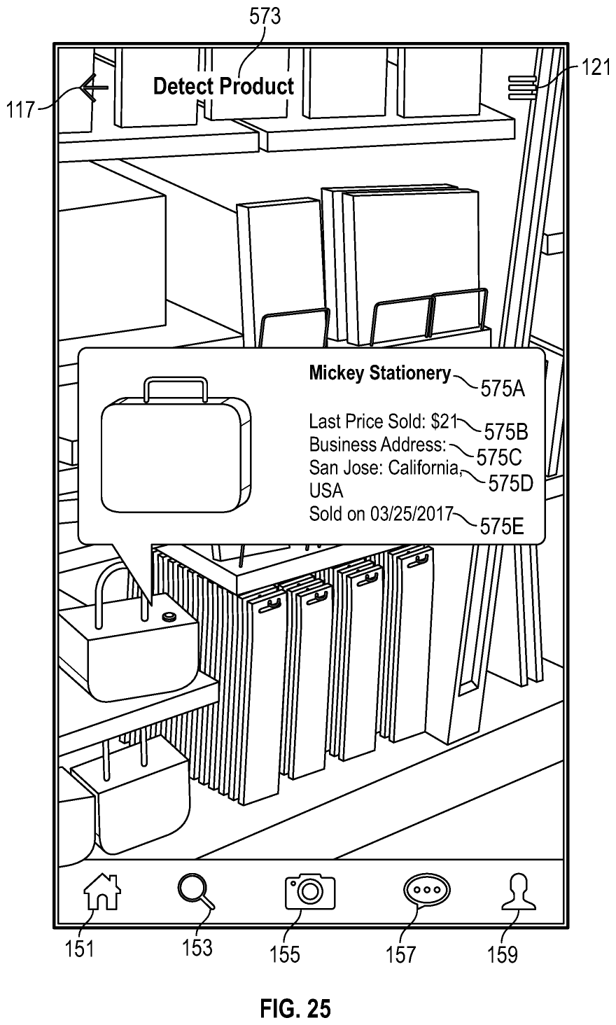

With reference to FIG. 24, in an embodiment, the user can obtain additional product information by going to the UI scan product page 569 and scanning a product of interest with a camera of the mobile computing device. With reference to FIG. 25, the user has scanned an object on a store shelf with the camera. The scan can be of a bar code, QR code or a photo of the product. This can or photo can be transmitted from the mobile computing device to the system server and information for the product can be accessed from the product database. This product information can be transmitted back to the mobile computing device and displayed. In this example, the name of the product that was detected 575A is “Mickey Stationery”, the last price sold 575B is $21, the business address 575B is 123 A street, San Jose, Calif., USA, and the date last sold 575E is Mar. 25, 2017.

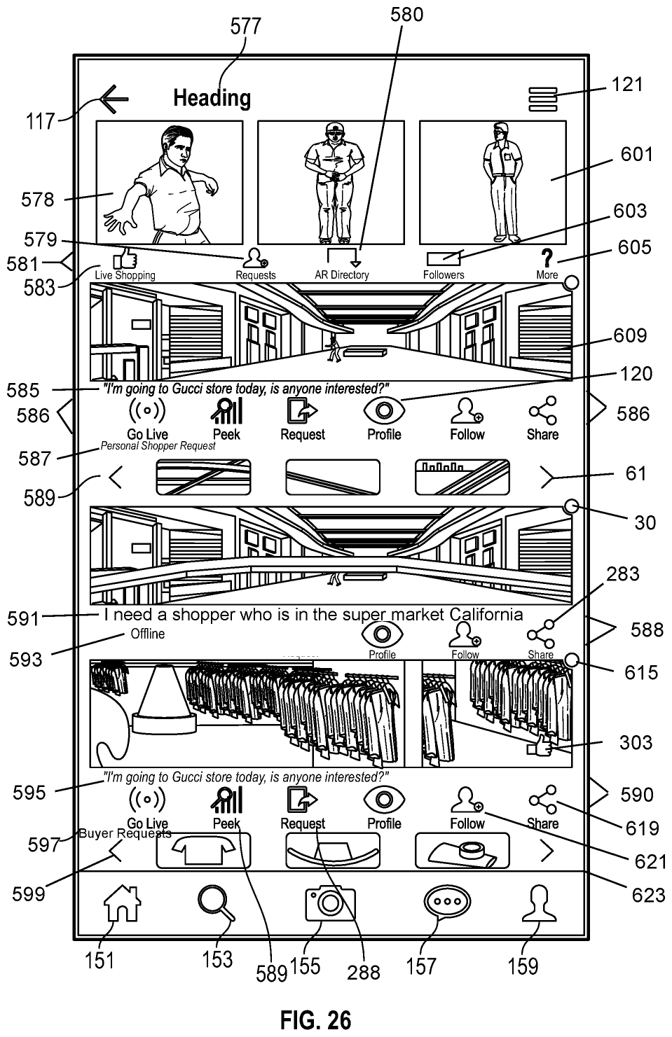

With reference to FIG. 26, the UI can have a “principal page” 577 which can be the main page where the user can see every request from personal shoppers, buyers and/or business on one page. The upper section 578 of the principal page” 577 can include a graphic is set by Sholcef which can be a header graphic that can be used for hot news or what buyers are currently shopping for, etc. that displays new trending product information. The page can also have a section 583 that includes buttons for: Live shopping, Requests, AR Directory, Followers, and More. A listing of system users can be displayed with information including: camera image of shopping location and quote from the shopper. The quote from Personal Shoppers or buyer can indicate where the personal shoppers are going to be shopping, location, what is requested by the buyers and where they are currently shopping related to the displayed photo. The displayed personal shopper information can include: store, live status, etc. As discussed, the buyer can use the controls to go live with one or more personal shoppers, peek preview of the personal shopper, submit requests, view profiles, follow and share. A request portion 599 of the principal page 577 can display a history of the buyer's product requests. In this example, the product requests are represented by photos of the products 623. The UI can have control buttons 599 that can allow the UI to scroll the product request photos 623. The user interface can be configured by the user to display answers to user questions. Buyer request photos can be moved higher on the user's computing device display. The buyer request photos can also be removed from the user's computing device display.

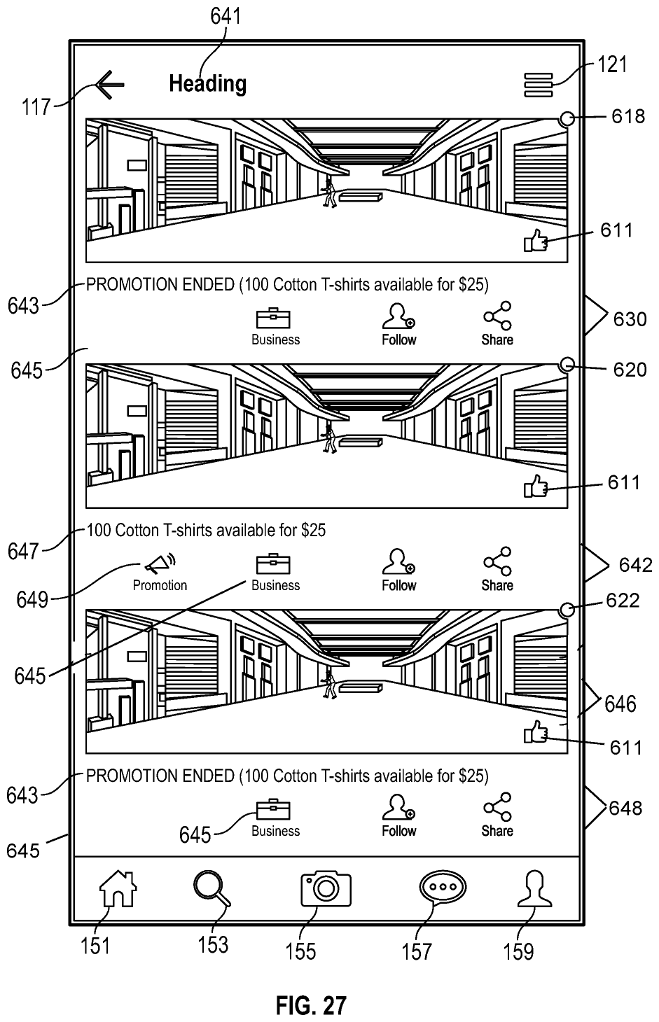

With reference to FIG. 27, the system can provide a business page button. When this button is pressed, the user's computing device can display Business Profiles with a listing of different businesses. Each listing can include photos 646 of the businesses, a business message such as an active sales promotion 647 or a message that the sale promotion has ended 643. For active promotions, a promotion button 649 can be displayed. A user can press the promotion button 649 to receive the promotion offer. If the promotion has ended, the promotion button is not displayed. Each business listing can also include a business button 645 which can be pressed links the user to selected business page, a follow button which causes the user to be a follower of the selected business and receive news and promotions and the share button which can allow a user to forward the business information to others.

Each system user can have followers and can follow others. The UI can have a switch that allows the UI to display the user's followers and a listing of people that the user is following. The user can select to display of followers and UI can display a list of followers and for each follower the UI can display the follower photo, name and email address. The list can also include follow buttons which can allow the user to follow any of their followers. When the user clicks on the follow button, the UI changes this button to “following”. The UI can display a listing of all people the user is following. The listing can include photo, name and email address. The list can include a button that includes unfollow buttons for each listing. By pressing the unfollow button, the user will no longer be a follower.

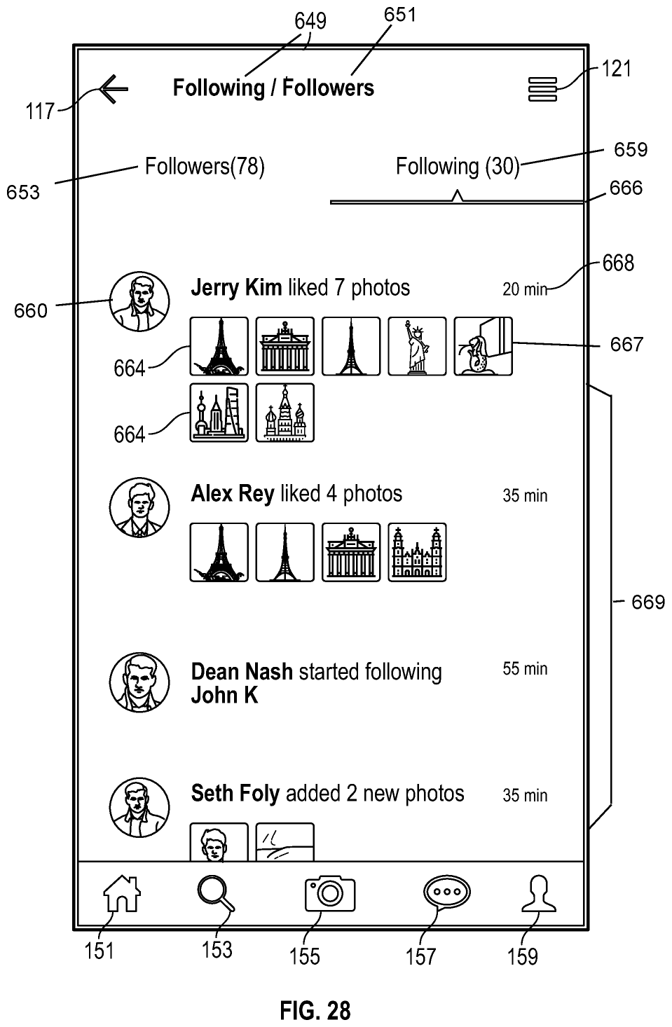

With reference to FIG. 28, the UI can display a listing of the activity of people that the user is following. In this example, the listing is organized in chronological order with the most recent activity displayed at the top of the UI. The listings can include a photo, name and activity description, and the time of the activity 668. The first listing is Jerry Kim who liked 7 photos 20 minutes ago. The 7 liked photos are listed 664. The next listing is Alex Rey who likes 4 photos 35 minutes ago. The third listing is Dean Nash who started following John K 55 minutes ago. The fourth listing is Seth Foly who added 2 photos 1 hour ago. The user can swipe down to scroll through older activity.

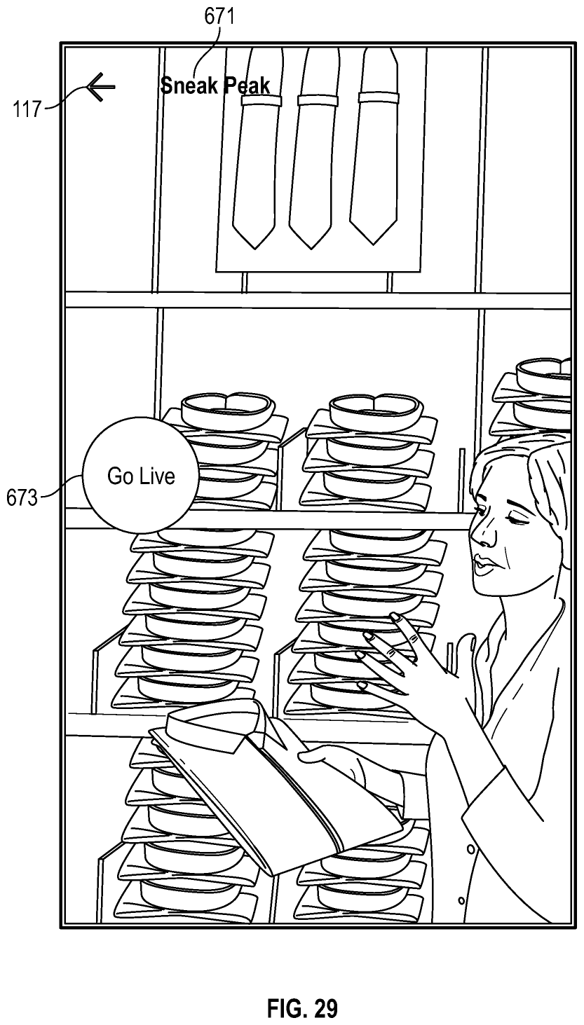

As discussed above with the buyer page, a listing of personal shoppers can be displayed. One of the buttons on this page is “sneak peak”. With reference to FIG. 29, when the buyer presses this button, the personal shopper is displayed live for a predetermined limited period of time. The buyer is only observing the personal shopper so there are no interactive buttons on the UI. If the buyer wants to use the personal shopper, the buyer can press the “Go Live” button 673. If the buyer does not wish to go live, the UI screen will revert back to the buyer page. If the buyer clicks on the “Go Live” button, but does not have sufficient funds, the system will display an error message. The buyer can with click the “Back” button to not go live or the “Add Money” button to add money to the buyer's account.

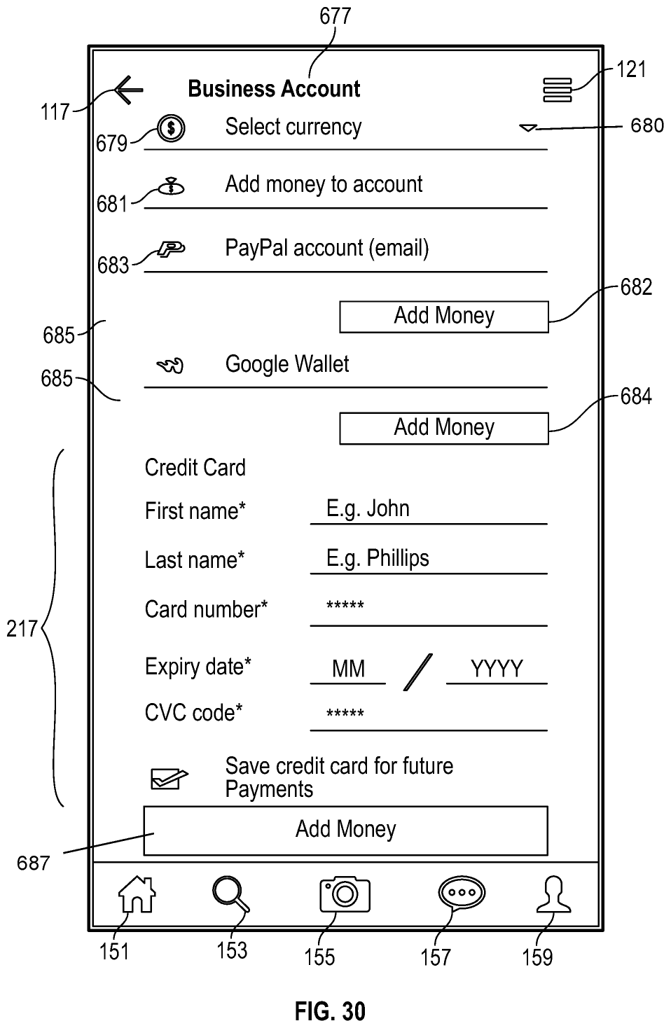

The UI can allow users to add money to their account. With reference to FIG. 30, the UI displays add money information which can include: currency selection 679, add money to the account 681, PayPal account 683 which can link the system account to the user's PayPal account, Google wallet 685 with an add money button 682, and credit card 217 with add money button 684. The user can select a money transfer method and then add funds to the account. If the user has attempted to go live but was rejected due to a lack of funds, the UI can display a message informing the user that the account is properly funded and asking if the user wishes to go live or go back to another UI page.

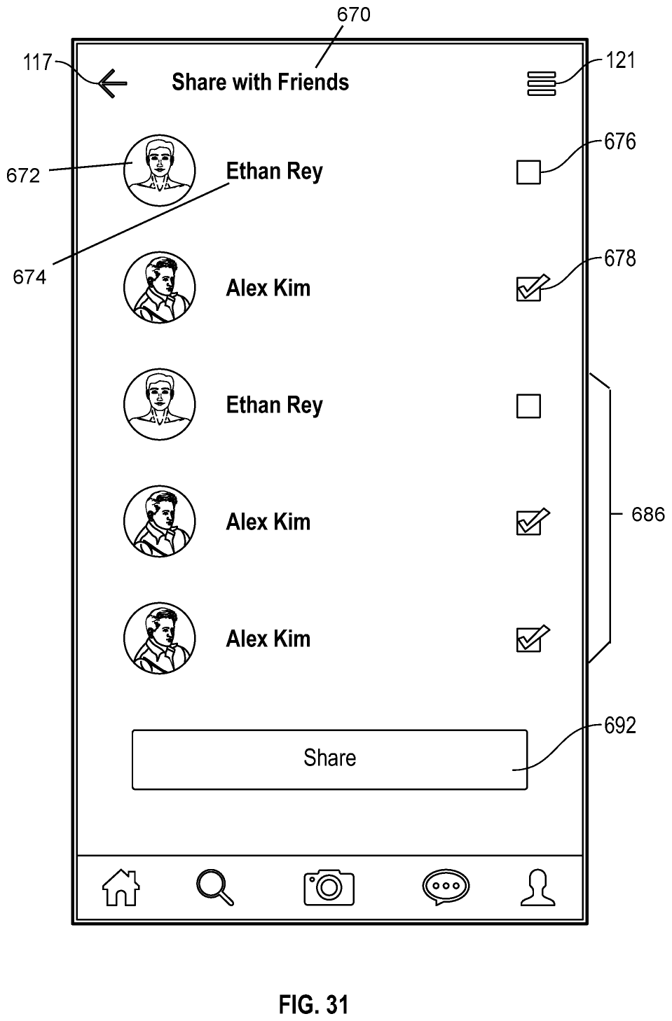

With reference to FIG. 31, the user has clicked the share button. The UI can display a listing of friends, which can include photos, names and buttons, which can be clicked to share the system information. The buttons 676 can all be blank when the UI share page is displayed. The user can click on the share buttons, which can cause the button to change to a check 678. The user can scroll through all friends and click the friends to share with. When the desired friends are selected, the user can press the share button 692 to transmit the data to all of the selected friends.

The system users can like any posted information or system user. When a user clicks the like button, the UI can display a confirmation screen. In this example, the user has liked an article and the confirmation message states, “Now you like this article.” The user can click the exit button to confirm this like or the unlike button to cancel the user's like of the article. The system users can dislike any posted information or system user. When a user clicks the not like button, the UI can display a confirmation screen. If the user has not liked an article the UI can display a confirmation message such as, “Now you do not like this article.” The user can click the exit button to confirm this like or the like button to change the user's not like to like of the article.

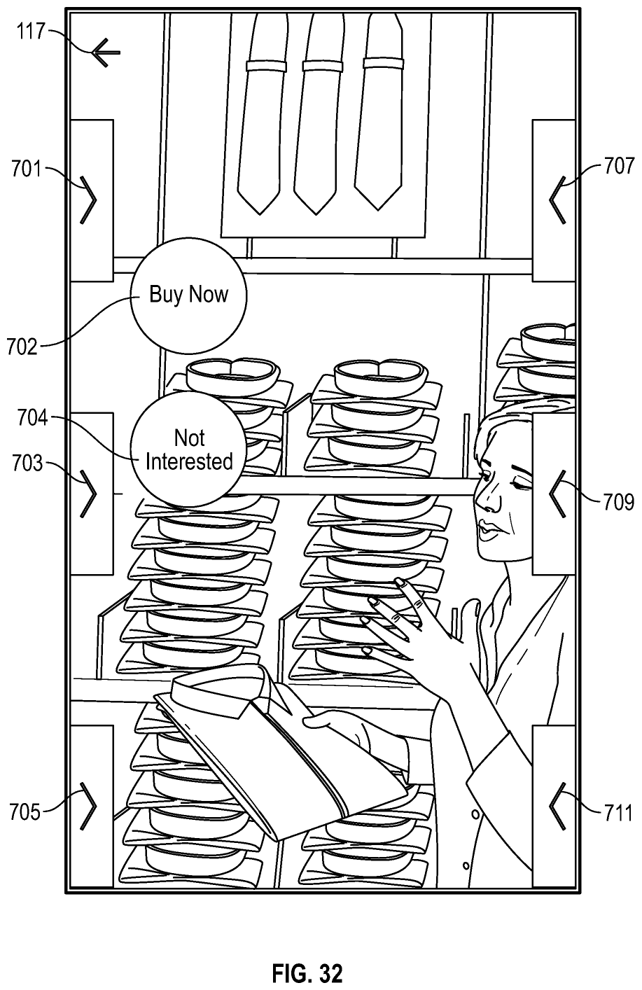

With reference to FIG. 32, the buyer has gone live with a personal shopper, the UI can display a video feed of the personal shopper who is showing a shirt to the buyer. The buyer can click on the buy now button 702 to purchase the displayed item or click the not interested button 704 if the buyer is not interested. The UI can also include additional menu buttons. In this example, there are several menu buttons including first menu button 701, second menu button 703, third menu button 705, fourth menu button 707, fifth button 709, and sixth menu button 711.

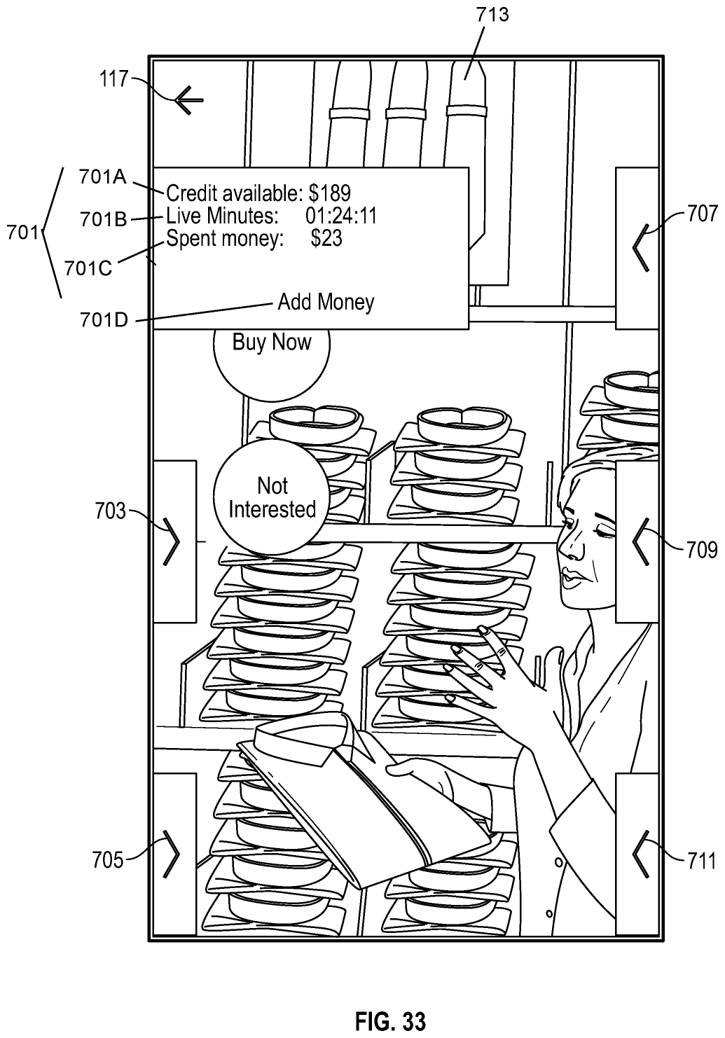

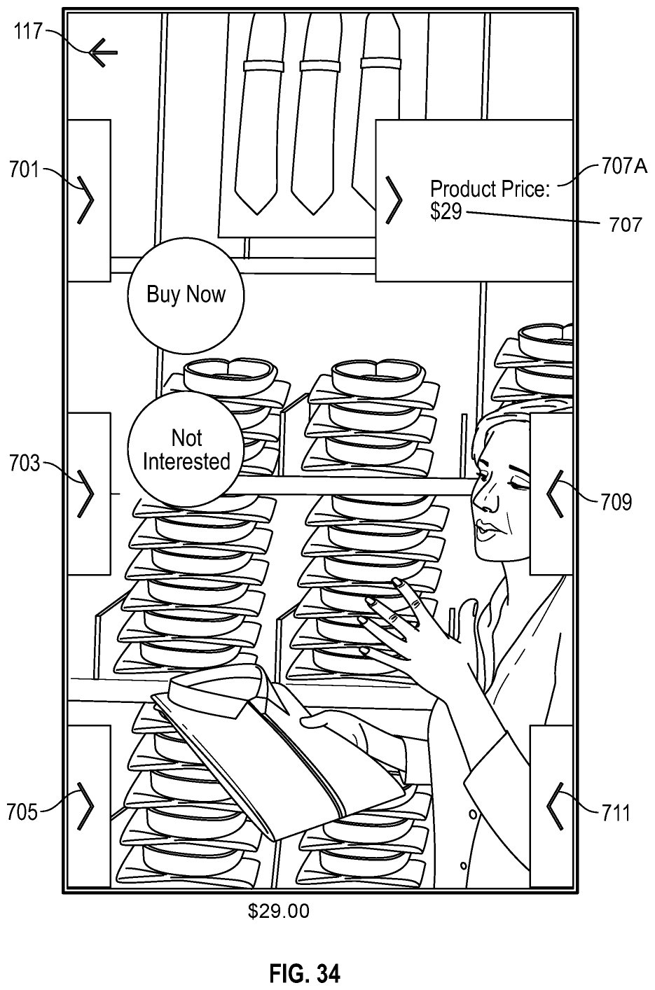

With reference to FIG. 33, the buyer has selected a first menu button, which displays account information. In this example, the account information includes: credit available: $189, Live minutes 01 hour, 24 minutes and 11 seconds. The menu also has an “add money” button 701D. With referenced to FIG. 34, the buyer has selected a second menu button which displays the product price 707. In other embodiments, the price can be displayed on the buyer UI when the product is presented for purchase 708.

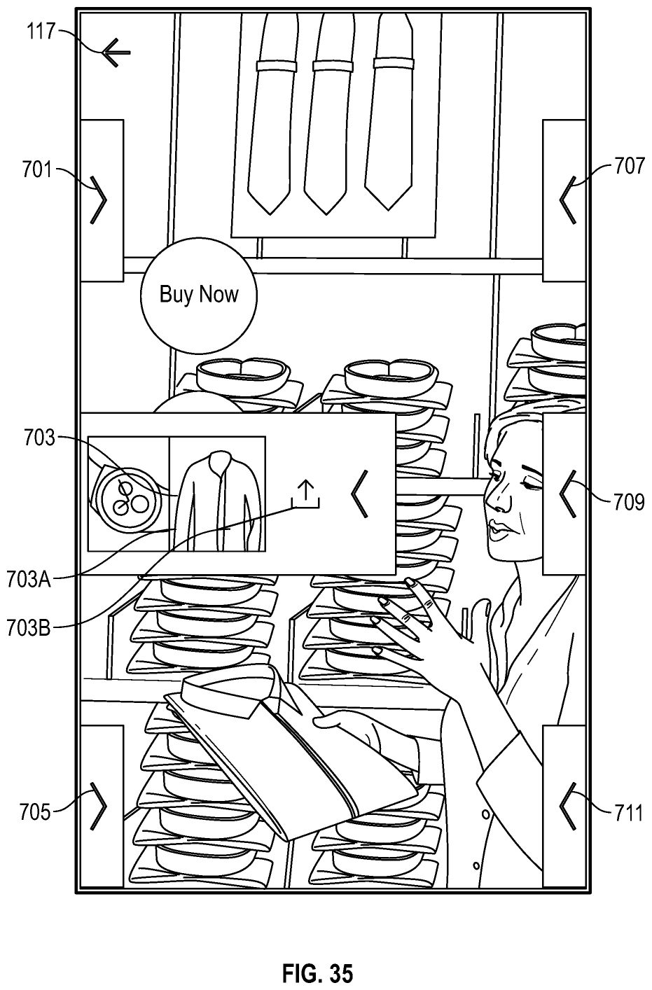

With reference to FIG. 35, the buyer has clicked on a third menu, which can result in the UI displaying a photo of the product 703A and an upload button 703B. The buyer may click on the photo 703A to see a larger view of the photo. The buyer can upload the photo so the photo can be stored on the buyer's mobile computing device or forward the photo to others.

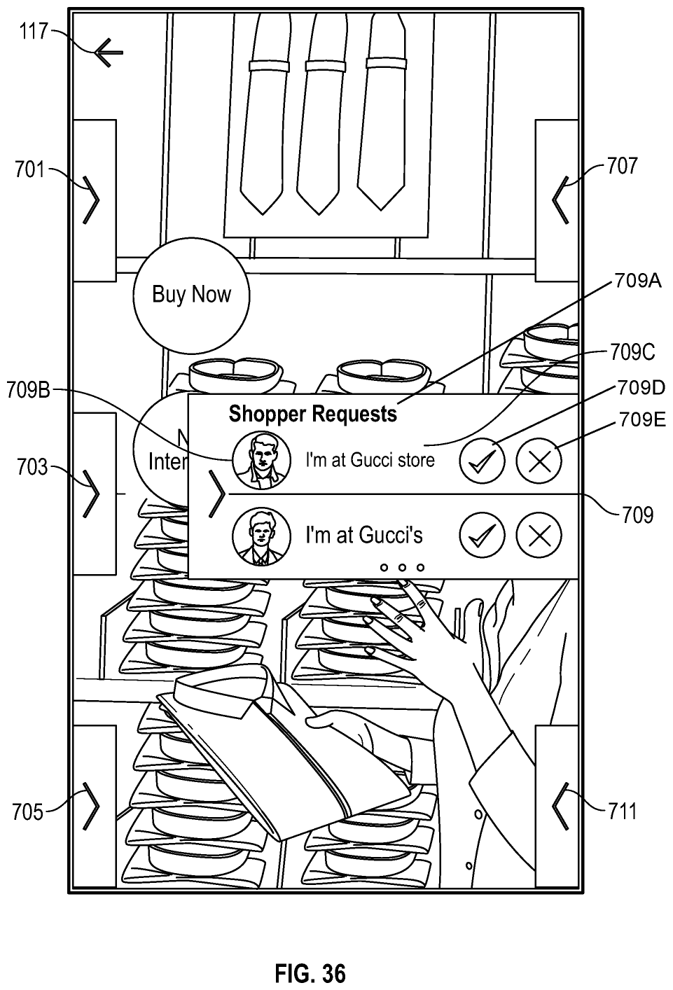

With reference to FIG. 36, the buyer has clicked on a fourth menu button, which results in the UI displaying shopper requests. In this example, a personal shopper has posted the message, “I'm at Gucci store” 709C with a photo of the personal shopper who is live and shopping 709B. The buyer can click on the green check button if buyer wishes to select/accept go live shopping with the personal shopper. The buyer will then be live with the current personal shopper and the newly selected personal shopper. The buyer can click on the red X if Buyer does not wish to go live with the personal shopper who is live and available.

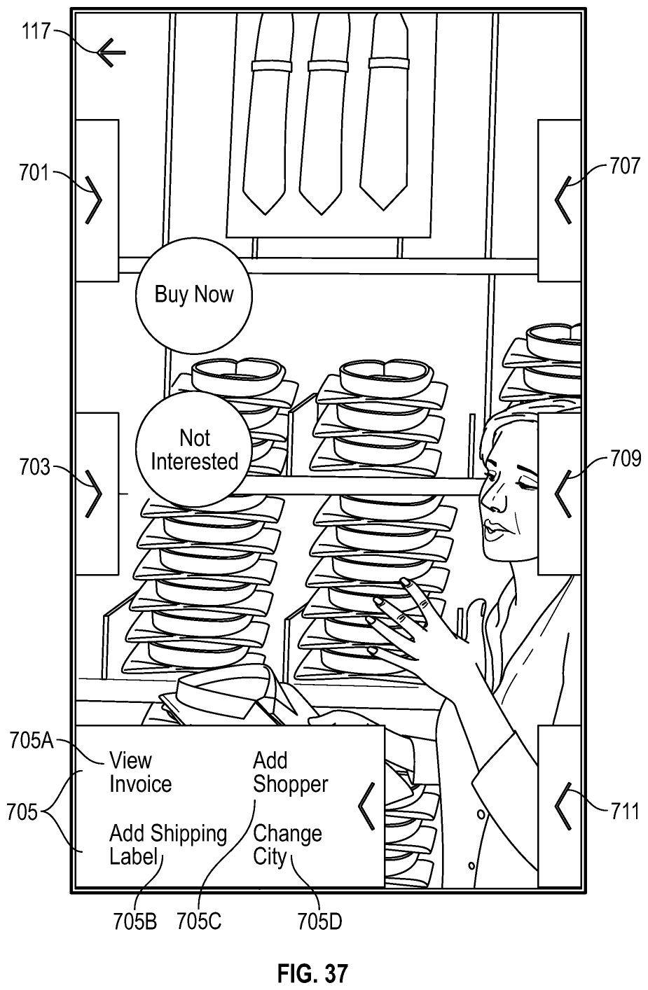

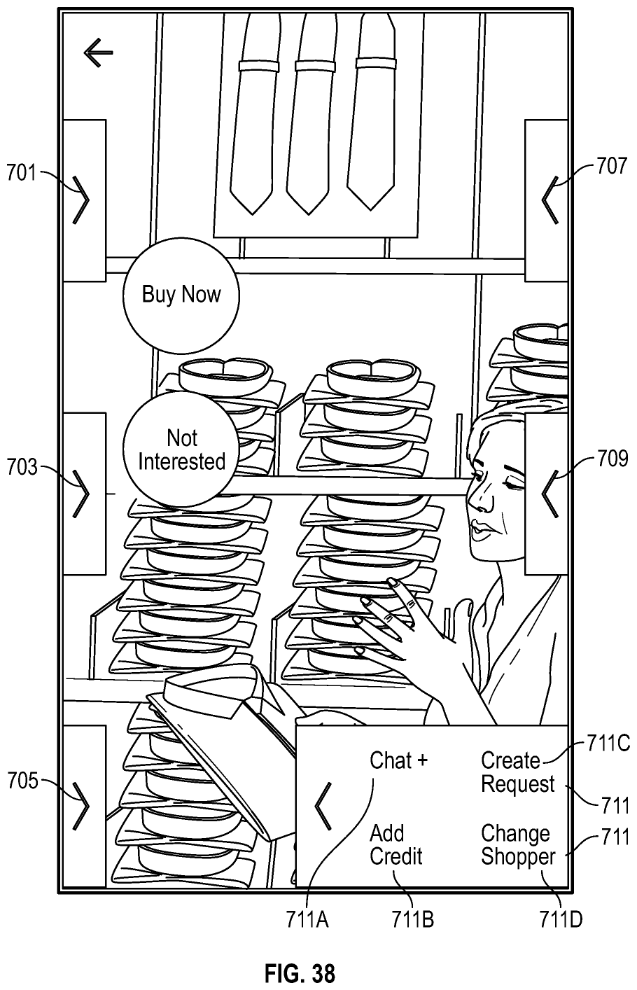

With reference to FIG. 37, the buyer has clicked on a fifth menu button, which displayed control buttons. In this example, the menu can include a view invoice 705A, add shipping label 705B, add shopper 705C and change city 705D. The user can click the view invoice 705A to view the existing invoice for the buyer. The user can click the add shopper to add any other on-line and available personal shopper. The user can click on the add shipping label button to add a shipping label so that the goods are delivered to the desired address. The user can also view other cities for personal shopping by clicking on the chance city button. With reference to FIG. 38, the buyer has clicked on a sixth menu button and the UI displayed additional control buttons including: chat 711A, Add credit 711B, create request 711C and change shopper 711D. The user can click the chat button 711A to allow the user to text with the personal shopper or any other system user. The user can click the add credit 711B to add funds to the buyer's account. The user can click on the create request 711C to create a buyer request message. The user can click on the change shopper 711D to select a replacement shopper from a listing of live personal shoppers. If the user clicks on the add funds button, the UI can display a funds transfer page.

If the user needs to transfer money to the system for purchases, the system UI can display a credit card data input page. The user can input the credit card information and press the save button. The system can process the funds transfer and the UI can display the “thank you” message. The user can press the exit button to acknowledge the funds transfer.

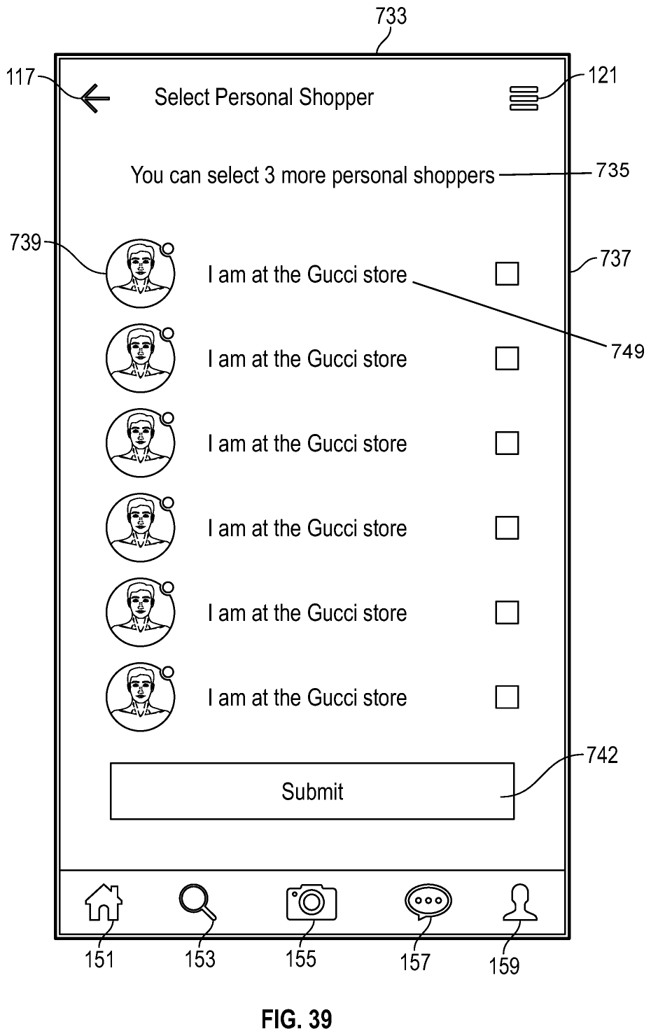

If a buyer clicks on the add shopper button, with reference to FIG. 39, the UI can display a select personal shopper page 733. In the illustrated embodiment, the UI can display a list of personal shoppers 739 which can include a photo of the personal shopper a light indicating the on-line status next to the photo (green light indicates on-line and red light indicates off line) and a message from the personal shopper indicating the store location of the personal shopper. The UI can allow buyers to select multiple personal shoppers and in this example, the system has limited the number of additional personal shoppers to three. The buyer can click on the select boxes 737 for personal shoppers. If the buyer clicks on three of the personal shoppers and if the buyer is already using a personal shopper, the buyer will have a total of four personal shoppers. In an embodiment, the buyer can click on the photo of the personal shopper to view additional information about the personal shopper. The buyer can click the submit button 742. The system can respond with the UI confirming that all of the selected additional personal shoppers are on-line and have accepted the buyer for personal shopping.

If all personal shoppers are not available, the UI will transmit a message to the buyer indicating the number of available personal shoppers and asking the buyer if they want to continue. Before the UI for the buyer goes live with the personal shopper(s), the UI will provide a billing message. The UI can informs inform the buyers that they will be charged a fee for example, $0.40 per minute for each personal shopper that the buyer is going live with. The buyer can then confirm these charges by clicking on an accept button or reject the changes by clicking on a decline button. If the buyer attempted to go live, but does not have sufficient funds, the system will display an error message asking the buy to reduce the number of personal shoppers or add money to the buyer's account. The buyer can add money by pressing the add money button or reduce the number of personal shoppers by clicking the back button on the UI. If a personal shopper goes off line before the buyer goes live, the UI will provide a message and a back button so that the user can revise the personal shoppers that the buyer will go live with. If the selected personal shoppers is properly configured, the UI can provide a validation acceptance message and allow the buyer to go live by pressing the go live button or reject this clicking on the back button.

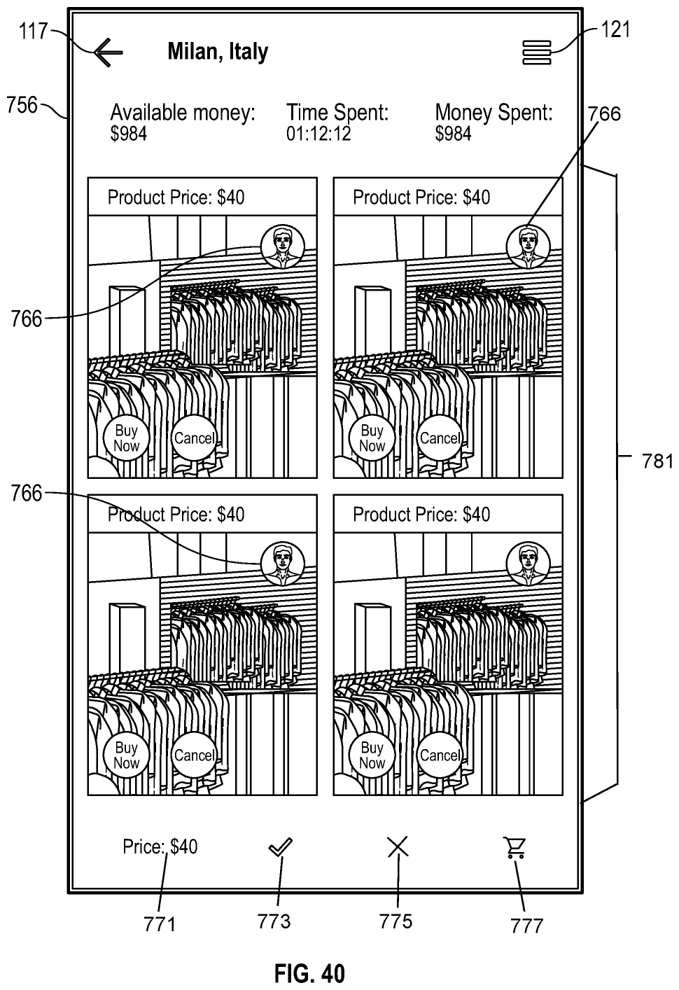

With reference to FIG. 40, an example of a buyer UI is displayed. The buyer has selected Milan, Italy as the shopping city as indicated on the buyer UI. The first personal shopper live window 766 and a second personal shopper live window 766 are both shown on the buyer UI. The UI can display the available money 756, the time spent 01:12:12 and the money spent. The first personal shopper section can display a live video feed with a proposed product purchase. The product price is shown as $40 and the buyer can click the buy now button to purchase the product or cancel to reject the product purchase. The second personal shopper section can display a live video feed with a proposed product purchase. The product price is shown as $40 and the buyer can click the buy now button to purchase the product or cancel to reject the product purchase. A third shopper can be shown on a lower portion of the UI display with a product that has a price of $80. The user can scroll down to view the third personal shopper product. In these examples, all personal shoppers are offering $40 products. For each of these products, the user can click the buy now button to purchase the product or cancel to reject the product purchase.

If a buyer discontinues the use of any personal shoppers, the UI can display a message asking the user if the buyer is sure that the personal shopper is going to be canceled. The user can click confirm to remove the personal shopper from the live shopping or a cancel button to cancel the removal of the personal shopper. If the personal shopper has been removed the system UI can inform the buyer with the message that the deleted personal shopper has been removed. The buyer can acknowledge this information and press the exit button on a UI.

After the buyer approves a product purchase, the system can display an upload your shipping label message. In different embodiments, the user can upload the shipping label by clicking on the upload picture button, take a picture, upload video and record video. In an embodiment, the shipping label can be created by inputting the shipping address information through a text input UI by the buyer, insurance options, and shipping speed options and pricing. In an embodiment, the shipping info can be saved and stored on the buyer database coupled to the system server. The buyer can access this shipping information future purchase shipping. Once the user has selected the shipping and insurance information, the user can click on the pay now button. When the pay now button is pressed, the UI can ask the user to confirm the terms and conditions by pressing an accept button. The user can reject the terms to cancel the purchase by pressing the back button. In an embodiment, the personal shopper may need to input the shipping prices. The system can transmit a message to the user indicating that the shipping prices have not been input into the system yet. The user can click on the exit button on the UI after reading the message.

When the buyer purchases an item, the UI displays a confirmation message. The user can click on the confirm button to finalize the purchase or back to cancel the purchase. When the purchase is confirmed, the UI transmits a message congratulating the buyer on the purchase and asking for authorization to automatically debit the purchase money from the buyers account. The buyer can click on the confirm button to authorize the funds transfer.

The buyer can switch cites for shopping through the change your city UI page. The buyer can input a country through a pull down menu, select a state, select a city, and a zip code. Alternatively, the user can click on any of the cities listed in the popular cities section. Once the buyer has selected a city or cities, the buyer can click on the submit button. The UI may have a popular cities page, which can allow the user can click on any of the listed cities. Once the buyer has selected a city or cities, the buyer can click on the submit button. The UI can list all of the available personal shoppers with photos and names in the buyer selected cities. The buyer can scroll through the listing of personal shoppers and select the personal shopper(s) that the buyer wishes to shop live with by clicking on the corresponding selection box. The selected personal shoppers can be indicated by check marks. Once the personal shoppers are selected, the user can press the submit button to proceed to the go live page as described above. If the buyer wishes to change the personal shoppers, a change shopper UI page can be displayed. The buyer can click on the shopper buttons to change the buyer's active personal shoppers. If any of the selected personal shoppers are offline and not available, the UI can display a message and the buyer can click on the back button to go back to the personal shopper selection page.

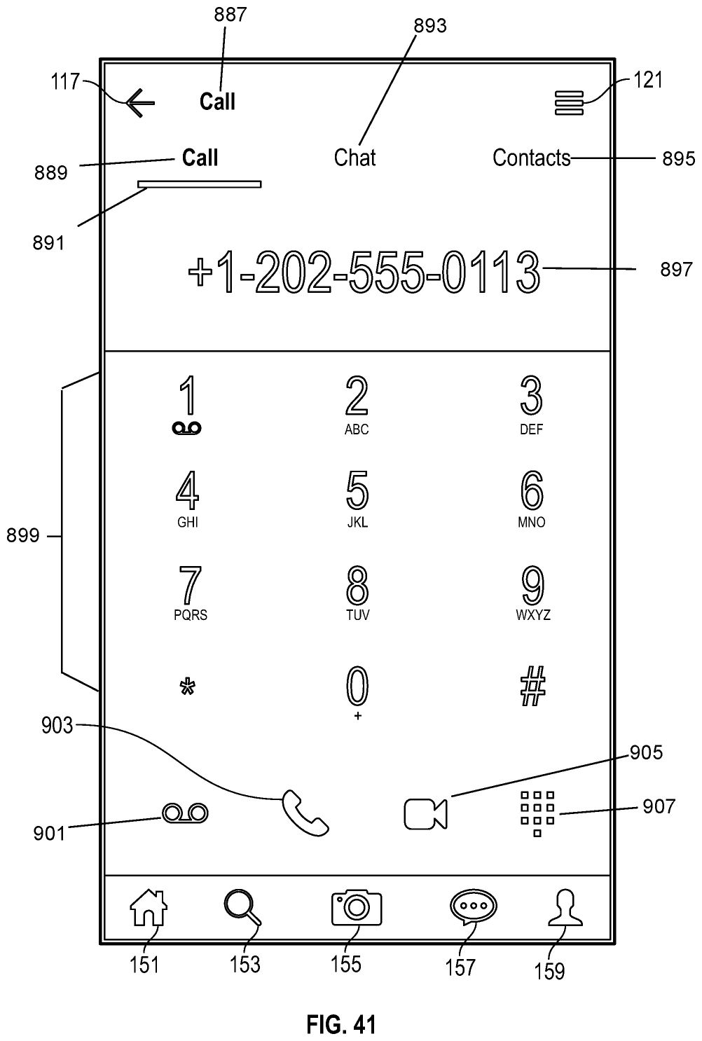

In an embodiment the system can a smart phone's phone and video features to perform the chat and video features to assist with personal shopping. With reference to FIG. 41, a user can click on the call button 889 and the UI can be in call mode as indicated by the green line 891 indicator. The user can then use a keypad to call a phone number, which can be a direct phone call to a shopper, or a conference call phone number for a multi party phone call. Once the phone number is entered, the user can click on the call button 903 to initiate the phone call. The user has initiated the phone call and the UI is displaying call options including: call time, video call, phone number, add call, volume, Bluetooth, speaker, keypad, mute and end call button.

In an embodiment, the user can click on the contacts button 895 and the UI can display a list of system users and the user can user can click on a plurality of the contacts call boxes. The selected contacts can be indicated by green check marks. Once the desired parties are selected, the user can click on the start group chat button. The group chat can be initiated and the photos of the chat participants can be displayed. The system can include an add button so that additional parties can be added to the group chat. The system controls can include: speaker, mute, hold, and end call. The group chat can include a chat initiator as described and chat participants. When the group call is made, the phones of the participants will ring. The participants can click the answer button to accept the call, click the video button to accept a video call, click on the end call button to reject the phone call or click on the reject call with message to reject the phone call with a message. Once the chat is initiated and the participants can be listed on the UI which can also display a photo, name, text message and chant time duration for each chat participant. The UI can also provide a profile update page which can allow the user to update a profile by adding the user's name, photo, address, description and message.

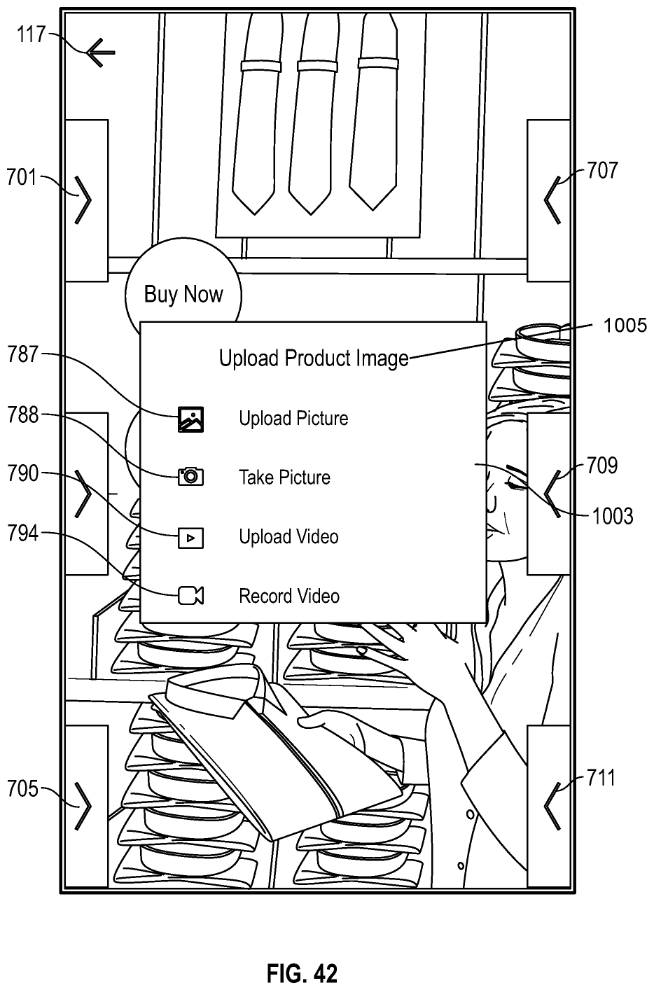

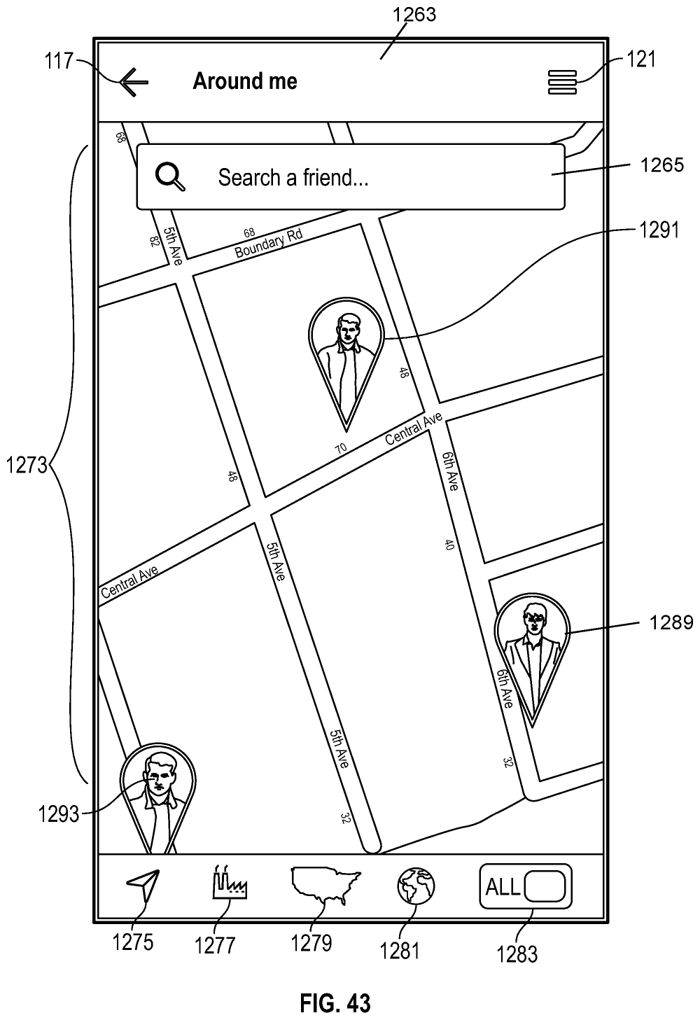

With reference to FIG. 42, the system UI can allow product images to be added to the product database. The user can click on the product image update button 1003 which can display an upload picture button 787, take picture button 788, upload video button 790 and record video button 791.

When the buyer has purchased goods, the system can issue an invoice for the purchased goods. The UI can have an invoices page which can allow a buyer to access and view their invoices. The invoices for a user can be listed by invoice numbers. For each invoice number, there is a plurality of controls including: view, download, and 1025. The buyer can click on the view button to view the invoice. The buyer can click on the download button the download the invoice to the memory of the user's computing device. The buyer can click on the delete button to delete the invoice.

When the user has clicked on the view button for an invoice the UI can display the information such as: name of the account; payment on the account-number of the account; telephone number. The invoice can include the product name “Product xx” and the dollar amount spent on the item, $27.33. The invoice can also include the value added services. The invoice can include added services are “subtotal” and the cost is $14.66. The invoice can also list the taxes, HST, HST cost ($5.46), Subtotal, subtotal dollar amount (($5.46), total current charges and total current charges dollar amount ($47.45). The bottom of the invoice can indicate the amount pay and the dollar amount to pay (($47.45).

In an embodiment, the inventive system can apply a specific algorithm for compensating the personal shoppers and the service provider for the personal shopping services. In an embodiment, the service fees can be a based upon the personal shopper's go live time spent with the buyer and the purchase price of the goods purchased by the buyer. Below is an example of a purchase commission algorithm. In other embodiments, any other commission algorithm can be used. In a first example, for purchases up to $1,000 the buyer can pay 0% of the purchase price of the goods and a fee of $0.40 for each minute of go live time spent with the personal shopper. For purchases between $1,000 and $10,000 the buyer can pay 1% of the purchase price of the goods and a fee of $0.20 for each minute of go live time spent with the personal shopper. For purchases between $10,000 and $50,000 the buyer can pay 2% of the purchase price of the goods and a fee of $0 for each minute of go live time spent with the personal shopper. For purchases greater than $50,000 the buyer can pay 3% of the purchase price of the goods and a fee of $0 for each minute of go live time spent with the personal shopper.

TABLE 1

| Purchase Price | Purchase Commission | Personal shopper time fees |
|---|---|---|
| $1-$1,000 | 0% | $0.40/min. |
| $1,000-$10,000 | 1% | $0.20/min. |
| $10,000-$50,000 | 2% | $0.00/min. |
| $50,000+ | 3% | $0.00/min. |

There will be additional shipping and tax costs, which will be paid by the personal shopper and paid by the buyer as described above. For simplicity, these costs are not discussed here. The personal shopper service fees can be split with 50% given to the personal shopper and 50% given to the service provider. In a first example, a buyer purchases $500 in goods over a time period of 50 minutes. The purchase commission is $0 and the personal shopper time fee is $0.40×50 minutes=$20. The fees can be split equally between the personal shopper and the service provider. In this example, the personal shopper and the service provider can both receive $10. In a second example using the same commission algorithm, the buyer has purchased $25,000 in goods. The purchase commission can be 2% of $25,000=$500 and the personal shopper time fee is $0. The personal shopper and the service provider can both receive $250.

When users register to use the inventive system the UI can ask the users if they have a business account or a personal account. If the user selects the personal account, the UI can display inputs for the personal account including, name, password, address, country, city, zip code, phone number, email PIN ID or password, and other information. The UI can then display an account input page. The user can input account information including: currency, add money to the account, PayPal account, Google wallet and credit card information. The user can add funds to the user's account through the UI. In an embodiment, the UI can also display a page that includes access buttons for information such as a system tutorial, a button for personal page set up, select shipping system button and how it works button. The UI can include a select category drop down menu button for selection of category i.e. purses, houses, shoes, cars, etc. The user can input information and click the Submit button. The system server can receive the information and store it on the user database for the user's personal account.

The UI can have a shipping selection page. The user can click on a listed shipper to select a shipping system from the shippers listed for delivering purchased goods. The UI can have an Add information page for personal shopper, buyer, business profiles, etc. When a user clicks on a rate a buyer button, the UI can display a rating page. The user can input a star rating and add a comment. Once the rating inputs are complete, the user can click on cancel to cancel or submit to post the rating on the buyer's page.

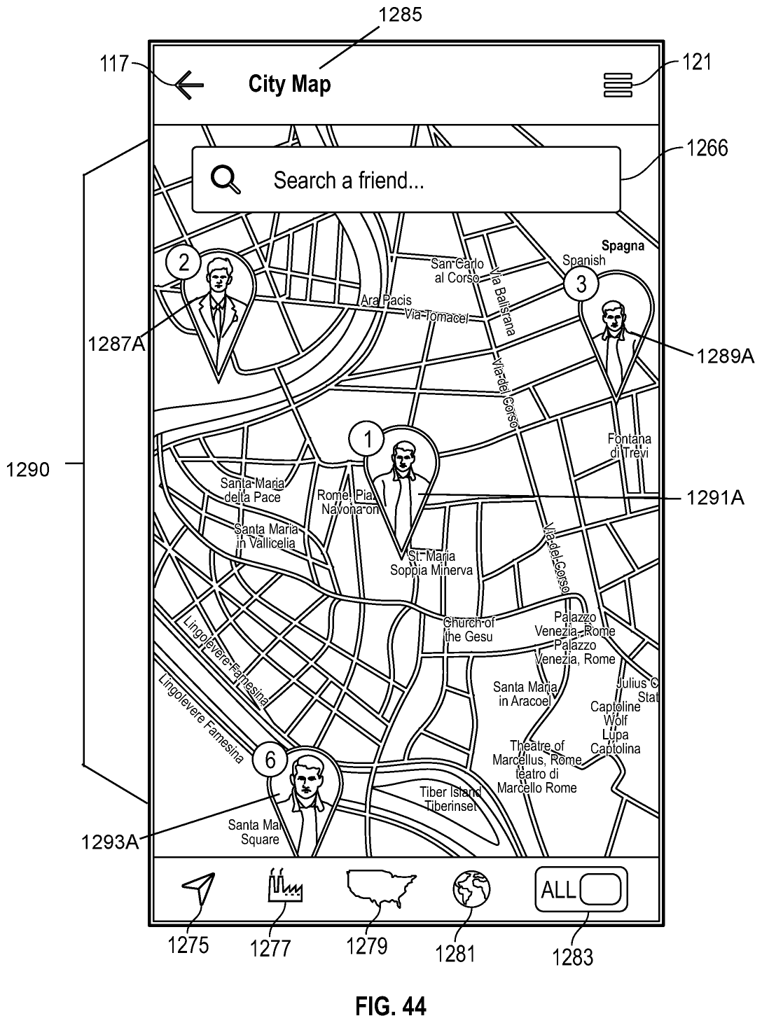

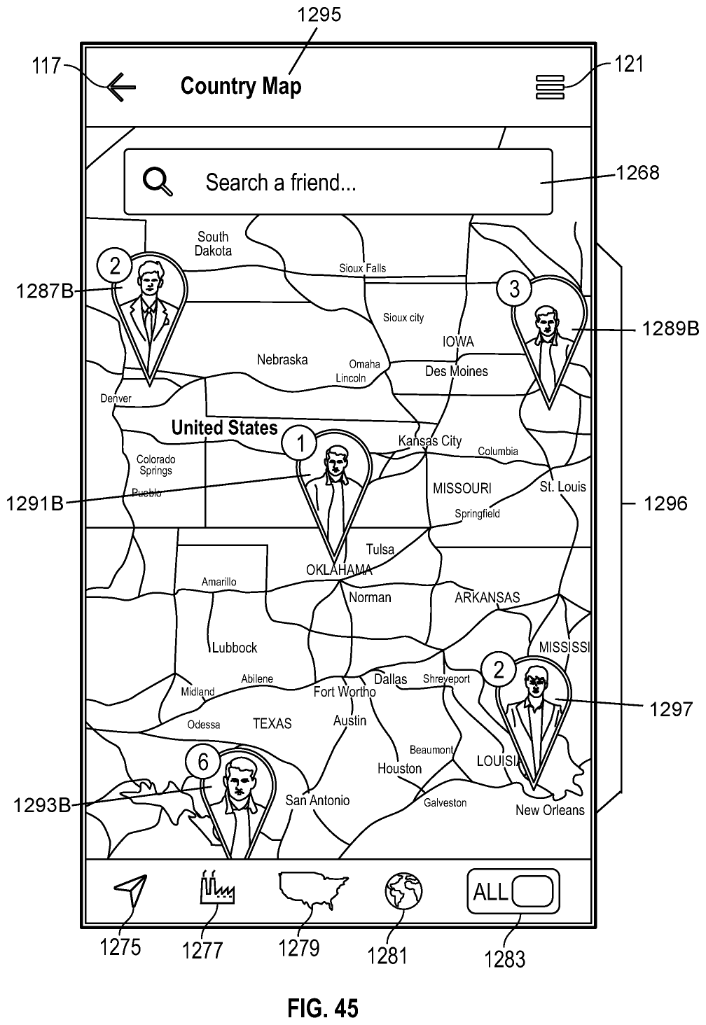

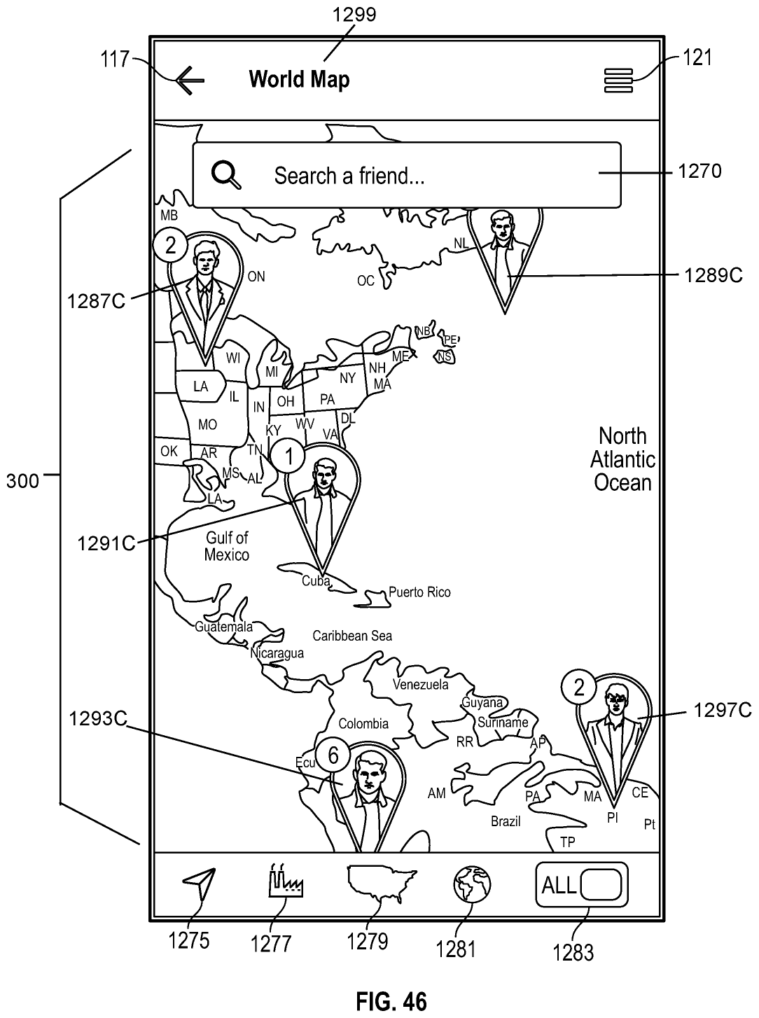

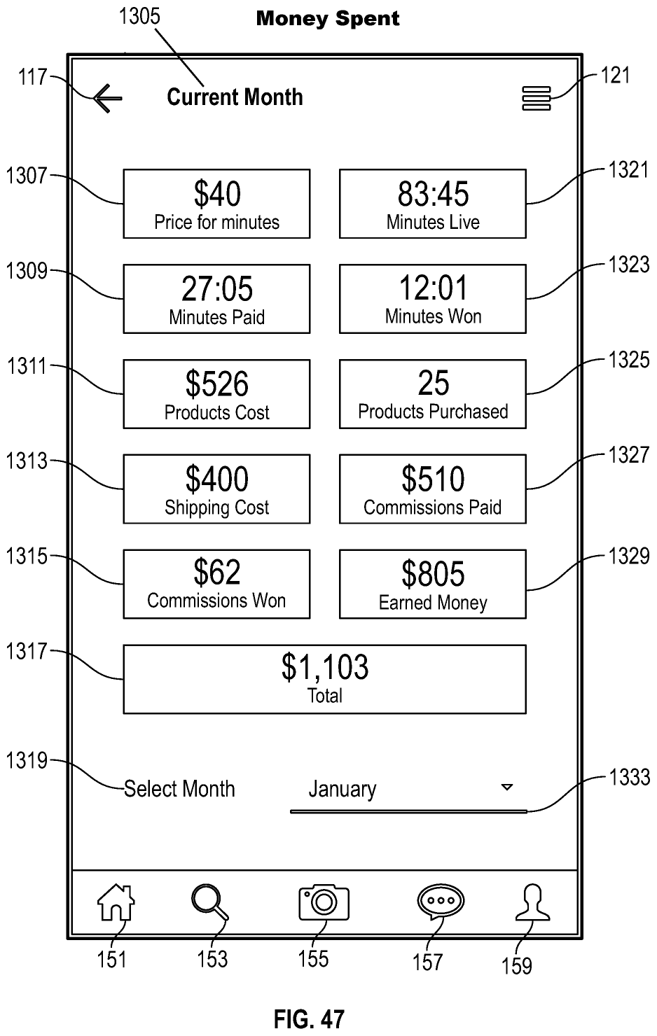

In an embodiment the UI can have a map features, which can be set by the user to “Around me”. This page can allow every user to see every friend, user, buyer, shopper and business that is live online nearby. The UI can also allow the user to input search information so that specific people such as friends can be found. With reference to FIG, 43, the map 1273 can display the locations of each system user 1289, 1291, 1293 in the area. The map UI can also have a feature for changing the scale of the map buttons such as city 1277, country 1279 and world 1281. In this example, the arrow button 1275 has been pressed and the people in the relatively small area are displayed. With reference to FIG. 44, the City map button 1277 has been pressed which allows users to see every friend, user, buyer, shopper, business that is live online in a selected city as shown on the illustrated map. With reference to FIG. 45, the country map button 1279 has been pressed which allows users to see every friend, user, buyer, shopper, business that is live online in the country as shown on the illustrated map. With reference to FIG. 46, the City map button 1277 has been pressed which allows users to see every friend, user, buyer, shopper, business that is live online worldwide as shown on the illustrated map. The UI can have a world-wide button 1283 allows users to see every friend, user, buyer, shopper, business that is live online around the world

The UI can provide information about a user's financial activity. With reference to FIG. 46, the user's Current Month invoice is displayed 1305 showing money spent and a tally of all categories of money spent. This information can include the money spent ($40) for personal shopper minutes 1307, the minutes paid (27:05 min) for the personal shoppers 1309, the product costs ($526) 1311, the shipping costs ($400) 1313, the commissions won ($62) 1315, the minutes live (83:45 min) 1321, minutes won (12:01) 1323, products purchased (25) 1325, commissions paid ($510) 1327, earned money ($805) 1329 and total ($1,103) 1317. The user can see different months by using the month control 1333.

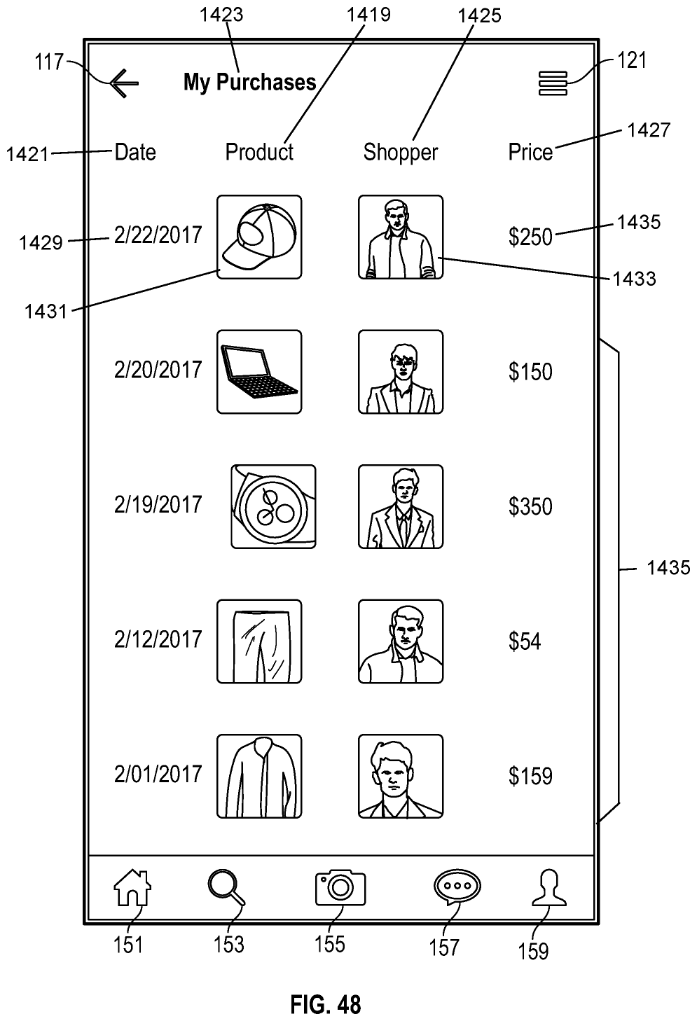

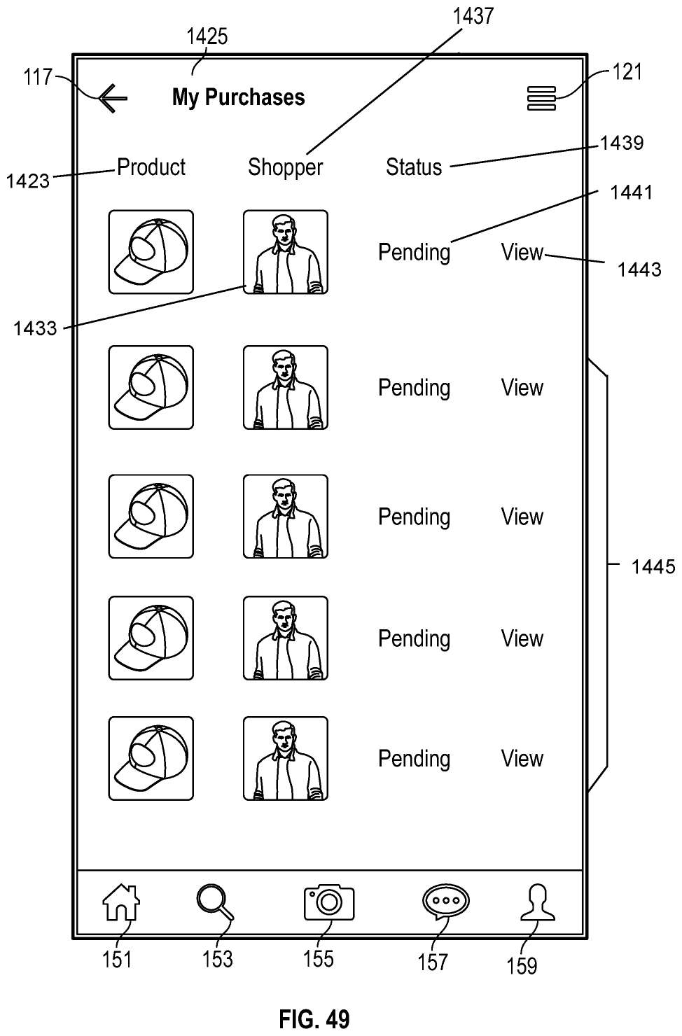

With reference to FIG. 48, the UI can provide a page My Purchases. This page displays all purchases, date, products, shopper name and price paid displayed on this page. Photos of the product purchased and the personal shopper who purchased the item for buyer are also shown in this example. With reference to FIG. 49, the UI can provide a pending shipping page, which includes a listing of items that have purchased but not shipped yet. The product photo, shopper photo, status and a button for viewing the purchase details are shown in this embodiment. The UI can allow users to obtain additional information by clicking on any of the product pictures. For example, the UI can display the product deliver status for purchased goods, shipping ID, tracking number, a status and a delivery date. The UI can provide a Sent Invoices Page that allows a user to view invoices and another options. The user can click on buttons to view details of the invoice number or click on the trash can to delete the invoice.

It is possible that there can be a transaction dispute for purchased goods. The user can input information about the transaction in dispute. This information can include: transaction name, transaction date, shopper ID and explain what happened.

When the dispute information is entered, the open this dispute button is pressed by the user. This page can also have a button that allows the user to view all dispute transactions.

The present invention has been described for personal shopping services. However, in other embodiments, the inventive system can be used for any other type of personal services such as: counseling, instruction, teaching, seminars, legal, medical, training, etc. For example, in an embodiment, a plurality of cook users may want to receive a cooking class at 6 PM when they are preparing dinner for their family. The cook users can have computing devices, which can access a cooking service portal provided by a system server. The cooks can choose the dinner from a listing of different meals and chef instructors. The user can have a UI similar to the buyer UI described above and the cook user can select the desired meal ahead of time. In an embodiment, the ingredients for the meal can be displayed and the user can purchase the ingredients and have the required cooking tools ready at the designated instruction time. In an embodiment, the UI can display an option to have the ingredients delivered to the cook's residence with a price and an order time which can be the latest time that a user can order and have the ingredients delivered to the home before the designated cooking instructions. The home cook can press a buy ingredients button of the UI to accept this offer or purchase the ingredients without the service. The user can receive instruction reminders based upon a calendar-stored schedule and the cook computing devices can “go live” at the designated instruction time. The chef can have a camera system similar to the personal shopper camera and computing device described above. The chef's computing device can transmit cooking instructions to the plurality of cooks and the cook computing devices can interact with the chef by asking questions, texting, sending photos and videos of their own cooking so the chef can provide feedback. The system can bill the cooks at the designated rate per second, minute, or at a fixed rate based upon the specific meal being prepared.

For example, in an embodiment, a plurality of system users may want to receive a legal advice for a specific legal topic. The users can have computing devices, which can access a legal service portal provided by a system server. The users can choose the dinner from a listing of different subjects and legal service providers. The user can have a UI similar to the buyer UI described above and the user can select the desired legal topic. The user can receive instruction reminders based upon a calendar schedule and the user computing device can “go live” at the designated instruction time. Alternatively, the legal service provider may be continuously proving content and the user can preview or go live as described above. The legal provider-computing device can have a camera system similar to the personal shopper camera and computing device described above. The chef's computing device can transmit legal information to the plurality of user and the user computing devices can interact with the chef by asking questions, texting, etc. so the legal service provider can provide feedback. The system can bill the users at the designated rate per second, minute, or at a fixed rate based upon the specific legal seminar being presented.

For example, in an embodiment, a plurality of system users may want to receive a training instruction for a specific exercise such as yoga, indoor cycling, etc. The users can have computing devices, which can access a training instruction portal provided by a system server. The users can choose the dinner from a listing of different exercise and instructors. The user can have a UI similar to the buyer UI described above and the user can select the desired legal topic. The user can receive training reminders based upon a calendar schedule and the user-computing device can “go live” at the designated instruction time. Alternatively, the training service provider may be continuously proving content and the user can preview or go live as described above. The trainer-computing device can have a camera system similar to the personal shopper camera and computing device described above. The trainer's computing device can transmit training instruction information to the plurality of user and the user computing devices can interact with the chef by asking questions, texting, photos, video etc. so the trainer can provide feedback. The system can bill the users at the designated rate per second, minute, or at a fixed rate based upon the specific training class being presented.

The present invention is directed towards a system and method for providing live services to a plurality of system users. The services can include personal shopping, instruction, lectures, advice, coaching, mentoring, professional services, etc. In an embodiment, the system users and service providers can have associated computing devices such as smart phones, which can communicate with a system server through a network. The computing devices can download software, which allows the mobile computing devices to share information such as audio, text, data, and video information. In an embodiment, the mobile computing device can download an application (app) program from the system server. The app can be stored in memory and run on a processor in the computing devices including mobile computing devices such as smart phones, lap top, desk top, wearable, and tablet computing devices. The type of computing devices used with the system can be based upon the needs of the system users. Personal shoppers may need to travel to various stores and/or departments within a store. Thus, a mobile computing device may be the most efficient way to interact with the inventive system.

In an embodiment the app can be the same for all system users or the system may provide a first app for buyers, a second app for service providers, and a third app for businesses. The app can be opened on the mobile computing device and the users can select the desired personal function as service provider or a service recipient. In other embodiments, the inventive system can have a separate service provider app and a service receiver app. To use the app, the user can click on an icon on the mobile computing device, which can result in a user interface being displayed on the user's computing device. In an embodiment, the app can display registration and terms and conditions information. The user can complete the registration process and agree with the terms and conditions to access the user interface of the app. The computing devices can include a visual display that includes buttons which can be input through a mouse, a cursor controller, touch pad, or other inputs.

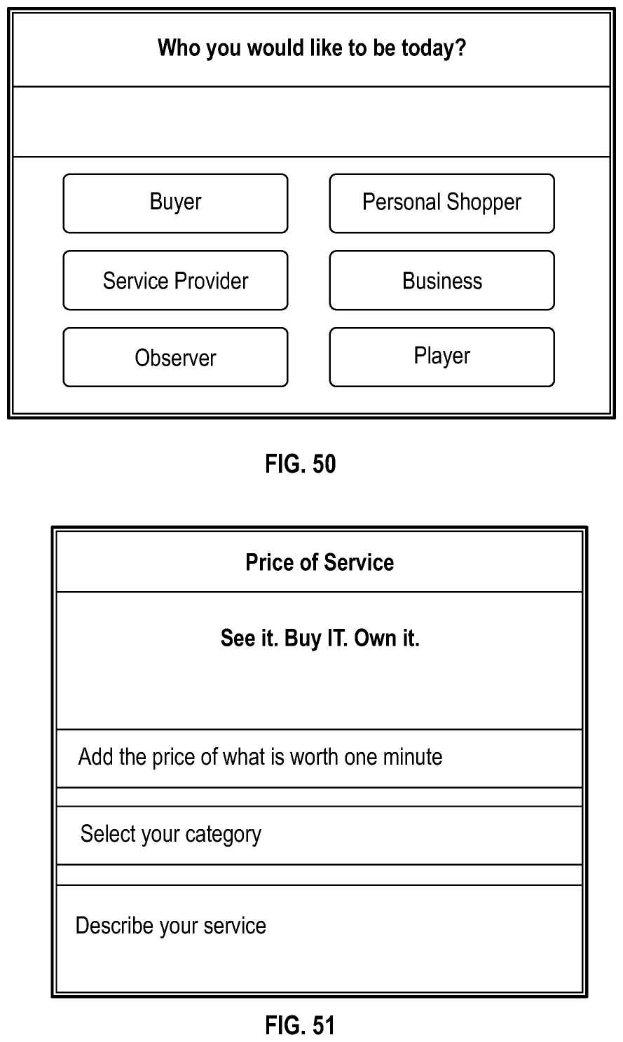

With reference to FIG. 50, the app running on the user's computing device in communication with a system server, can open a user interface can allow the user to navigate through various system controls. When the user opens the app, the user interface can display a variety of user options. In this example, the system can ask the user, “Who you would like to be today?” with the options of: Buyer, Personal Shopper, Service Provider, Business, Observer and Player. In other embodiments, the system can allow other options. The user can select any of the listed options and the system will respond by providing the user interface that matches the user's selected option.

With reference to FIG. 51, when the user selects to be a service provider or a buyer, the system can ask for the price per minute for each watcher buyer. The UI can also have inputs for the service provider's category and an input for the description of services being provided by the service provider. The input rate possibly minus a service charge if the service provider is paying the service charge or possibly plus a service charge if the buyer is paying the service charge will be charged to the computing device for each service recipient and each of the other buyers for receiving the services from the service provider user. The user interface can also display or provide a link to a contract for the agreement to offer the services. The user may need to sign the contract agreement or digitally agree with the terms of service in order for the system to allow the user to provide live services on the system. The service provider's information will be added to a database of users and the service provider's description of services will be displayed on a listing of service providers which can be viewed by system users and used to select a service provider.

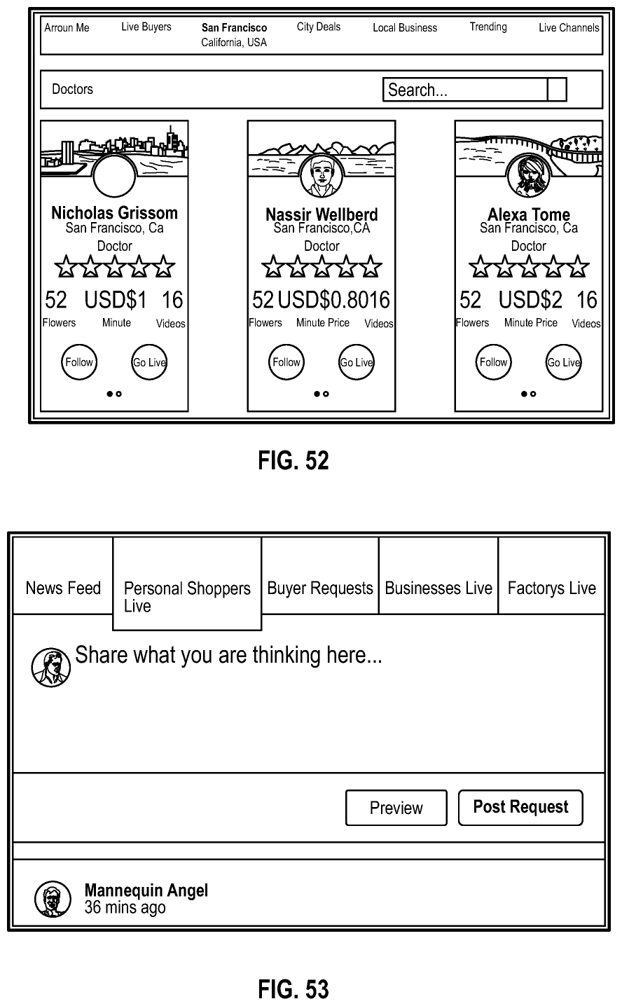

When buyers use the system, the users can log into the app and select the buyer or observer options. The system can allow the user to select the desired service and possibly a location such as the city of San Francisco, Calif., USA. With reference to FIG. 52, an example of a user interface can display a listing of service providers physically located in San Francisco. In an embodiment, the service categories can include: teachers, accountants, doctors, etc. The user can click on the doctors category and the system UI can respond by displaying a plurality of doctors who are currently available for live services in San Francisco. The system can display various information for each of the listed doctors including: a photo, name, city, service provided, rating (such as a star rating in this example), number of followers, price per minute for live services and number of reviews. The user can click on the follow button to receive posted information from the service provider. The user can click on the go live button to establish direct communications with the doctor.

If the user clicks on the buyer services, the system can display a plurality of buyers. The system can display various information for each of the listed buyers including: a photo, name, city, service provided, number of purchases, number of product searches and number of live times. The user can click on the follow button to receive posted information from the service provider. The user can click on the go live button to establish direct communications with the doctor.

When a user clicks on a service provider's button, the user interface can display additional information about the service provider. The personal shopper's information can include personal shopper introduction information including: information about the shopper, favorite TV show and photos. The user interface can also include a menu of additional controls. In this example, the menu includes: timeline, news feed, change city, go live, live services, live personal shoppers, sneak peek, city deals, trending, live channels. In this example, the personal shopper's timeline is displayed which can include the activities of the personal shopper displayed by most recent activities.

With reference to FIG. 53, if the user clicks on the new feed, the user interface can display posts from the personal shopper. The news feed may include a post request button. If the user wishes to post requests such as purchase requests, the user can type the request into a text input box and then post once the request text is completed. The user interface can also post information about the buyer. In this example, the buyer introduction information can include: introductory text, products that the buyer is looking for, brands, today's budget and location. In an embodiment, the buyers and shopper can communicate with each other through this text exchange user interface area.

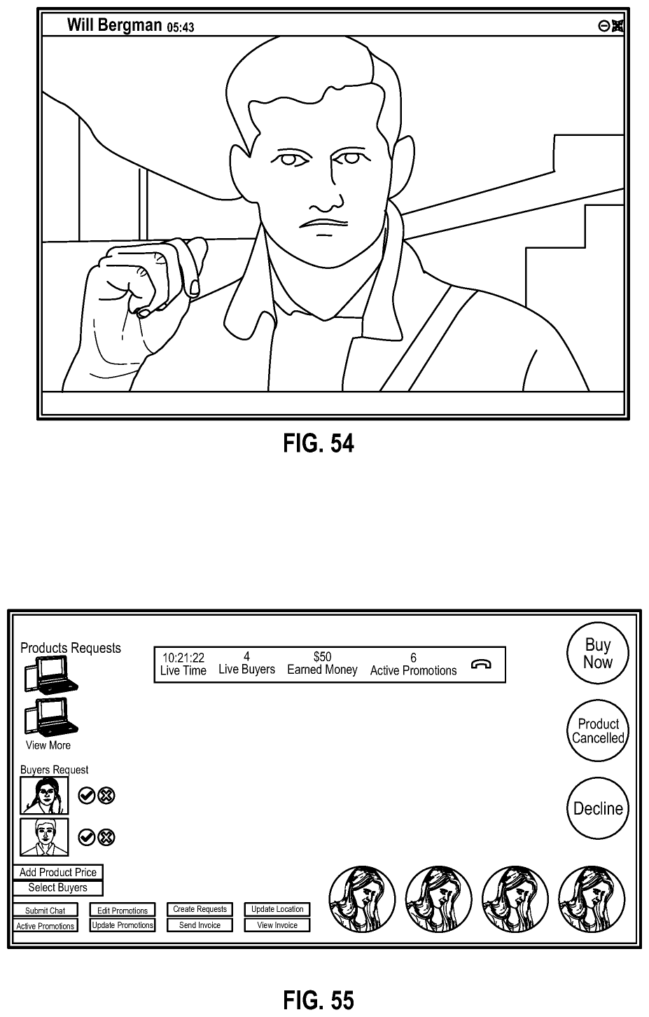

With reference to FIG. 54, when a user click on the Go Live button, the user interface can display a live video feed from the personal shopper. In an embodiment, the personal shopper has placed the camera in front of himself so that he can communicate directly with the system users who have clicked on the go live button. As discussed above, the personal shopper can have a service fee based upon the time that the user is live with the personal shopper. In this example, the name of the personal shopper and the time that the personal shopper has been live is displayed.

In an embodiment, the user interface can include a listing of known contacts of the system user with an indicator of whether the contacts are on-line or not. In this example, the green circle can indicate that the contact is on-line and available. A red circle can indicate that the contact is off-line. A yellow circle can indicate that the user is on-line but unavailable. The user can click on the photo to be connected to the contact.

Each personal shopper can be live with multiple buyers. FIG. 55 illustrates an embodiment of a user interface for personal shoppers with multiple buyers. The top bar in this example can display the live time, the live buyers, the earned money, active promotions and call termination. In this example, the personal shopper is providing services to four buyers. Photos and names of the buyers are displayed. The money earned is based upon the time that the shopper is live with each of the buyers and the billing rate of the personal shopper. The personal shopper user interface can include product requests, which have been submitted by the buyers and specific buyer requests. In an embodiment, the personal shopper can click on the product requests to obtain more information about each request. In an embodiment, the personal shopper can accept a buyer request by clicking on a green accept button or reject the buyer request by clicking on a red reject button. As the personal shopper shops, the video of the proposed products for purchase can be displayed and the buyers can issue purchase commands to the personal shopper, which can include: buy now, product cancelled and decline. When a personal shopper is instructed to buy now, the personal shopper will purchase the product. Conversely, when a personal shopper is instructed to decline, the personal shopper will not purchase the product. In some cases, the product may not be suitable for the buyer. For example, the product may not be available in the: color, size, pattern, etc. that is required by the buyer. In these situations, the product can be cancelled and not purchased by the personal shopper.

The personal shopper user interface can also include additional controls including: add product price, select buyers, submit chat, edit promotions, create requests, update location, active promotions, update promotions, send invoice and view invoice. When the buyer clicks on the “add product price”, the product price can be transmitted to the buyers. When the select buyers button is pressed, the personal shopper can select the buyer for individual communications or interactions that can be separate from the other buyers. For example, an invoice for a single buyer should not be shared with all of the other active buyers. The user can click on submit chat to access the chat features of the app. The personal shopper can click on the active promotions button to get a listing of active product promotions. The personal shopper can click on the edit promotions button to edit the product promotions. The personal shopper can click on the update promotions button to update the product promotions.

When the personal shopper moves, the update location button can be pressed. In an embodiment, the location of the personal shopper can be based upon GPS information received by the mobile computing device or other location signals such as Wi-Fi information. In other embodiments, the personal shopper may need to enter location information manually, if there are no other location signals that are received by the mobile computing device.

The personal shopper can also press the view invoice button to see an invoice for the buyer and send the invoice when the shopping is completed. The send invoice button can cause an invoice document to be sent to the buyer and the funds for the purchase of the goods can be transferred from the buyer's account to the personal shopper's account through the server.

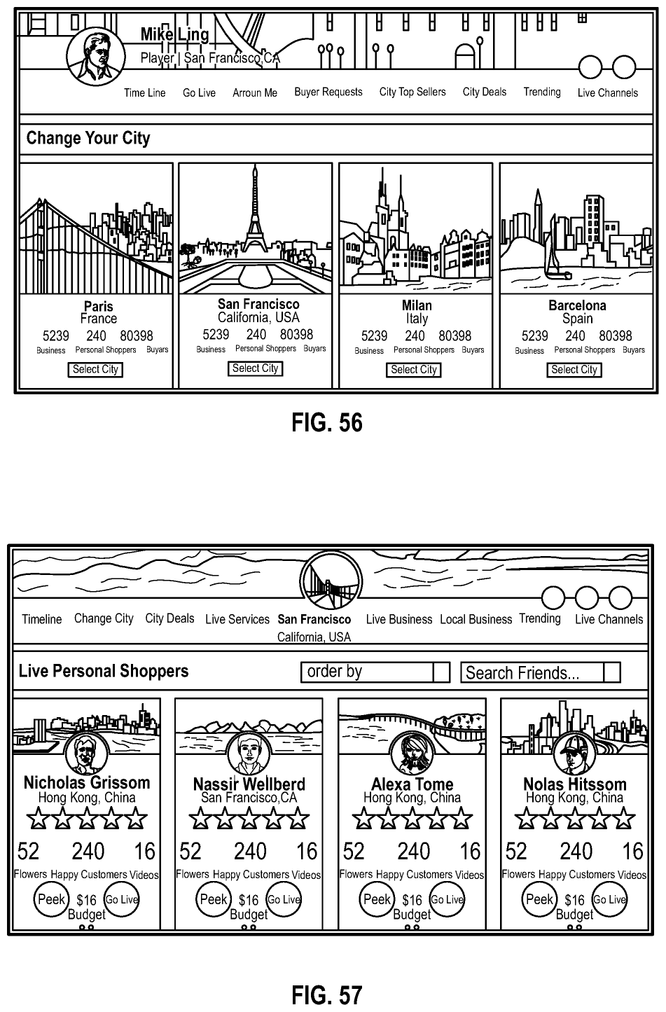

With reference to FIG. 56, when the buyer clicks on the change city button in the user interface, the system can display a plurality of other cities for shopping. In this example, the user interface displays: Paris France, San Francisco USA, Milan Italy, and Barcelona Spain. For each city, additional information can be displayed. In this example, the user interface displays a photo of the city, the number of businesses, the number of personal shoppers and the number of buyers. The user can click on the select city button to product a listing of personal shoppers in the selected city.

For example, the user can click on the San Francisco button and a listing of personal shoppers in San Francisco is shown. With reference to FIG. 57, the user interface can display a photo and the name of the personal shoppers as well as buyer ratings in the form of stars. The user interface can also display the number of followers, number of happy customers and the number of videos posted by the personal shopper. The buyer can use the user interface to input a budget. The user can click on the peek button to receive an unbilled period of time of live video feed from the personal shopper. Alternatively, the user can click on the go live button to receive a billed live video feed from the personal shopper.

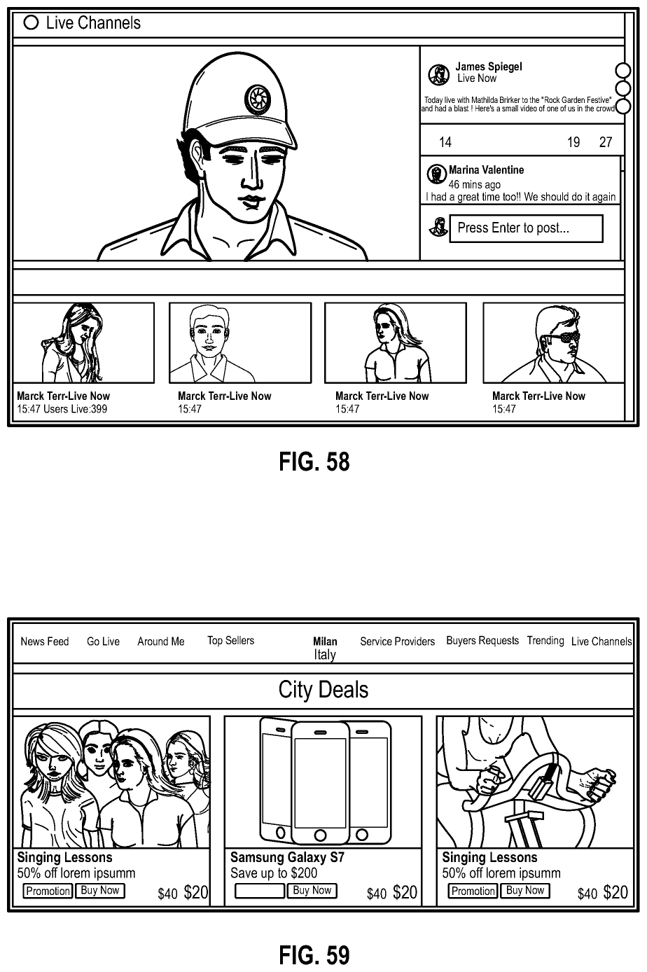

The video feed from the personal shopper(s) or service provider(s) can occupy most of the visual display of the user's computing device which can be a mobile phone, tablet, lap top, computer, etc. In other embodiments, the go live user interface can be configured based upon user preferences. With reference to FIG. 58, when the buyer has clicked on the go live button, a live video feed of the service provider is displayed on a portion of the visual display. In some applications the video display can be based upon the size of the computing device display. In this example, an office computer with a large monitor can fit several video feeds from several different service providers as well as a text messaging section where people can post comments during the live video feeds. The video feeds can specify the name of the service provider and the status of the video feed. The Live Now text can indicate that the service provider is currently streaming live.

In addition to providing an interactive communications platform for service providers and service recipients, the inventive system can also be used as a means for advertising goods and services in different cities. In an example, the user can select the city of Milan Italy. With reference to FIG. 59, the user has clicked on the City Deals button on the user interface and the system can display a photo, a basic description, and savings information for local Milan Italy deals for goods and/or services. The user can click on the promotion button to get more information on the offer or press the buy now button to purchase the promotional goods or services. The buyer user can click on the Around Me button to pull up a street and/or satellite image map that can show the area around the user. In an embodiment, the system can display businesses that can provide goods and/or services to consumers and points of interest. Thus, the inventive system can be used to assist users with traveling to other cities.

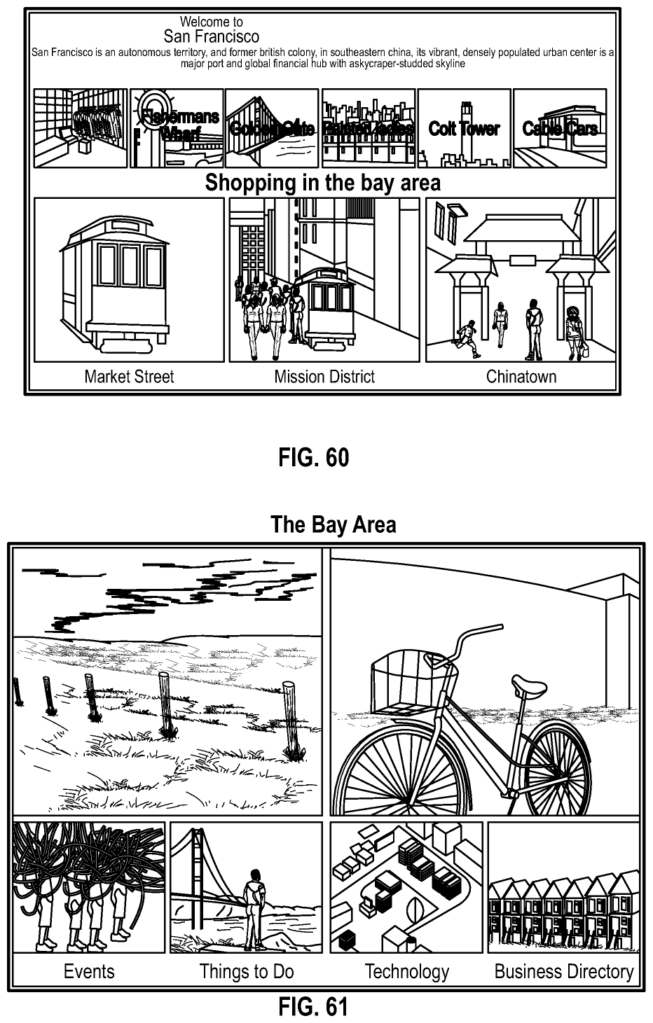

With reference to FIG. 60, the user can click on the trending button to access information about the location of the user and possibly interests of the user. In the illustrated example, the user is located in San Francisco and the system has displayed information about local attractions including: market street, the mission district and Chinatown. The user interface also has photos of shopping, Fisherman's Wharf, Golden Gate, Painted Ladies, Coit Tower and cable cars. The user can click on any of these photos for the system to display information about these points of interest.

With reference to FIG. 61, the user can scroll down on the trending menu and see additional information about the Bay Area surrounding San Francisco. In this example, the user interface displays photo buttons for Napa Valley and Silicon Valley. The user can click on any of these photos for the system to display information about these areas. The user interface can also display additional categories including: events, things to do, technology and business directory. The user can click on any of these photos for the system to display additional information on these topics.

The user interface can have a local business button. When this button is pressed, the user interface can display local businesses based upon the user's location or selected city. In this example, the user interface displays photos or logos of local businesses, the name of the business, the description of the business, a rating, the number of followers, the number of happy customers and the number of promotions. In an embodiment these businesses can function like personal shoppers or these local businesses can have employees who can provide personal shopping services. The buyers can click on the peek button for non-billed a sneak peak at the stores goods or services or click on the go live button to access the businesses actual or virtual personal shopper. In some embodiments, the businesses may not charge a fee for these personal shopping services as a store promotion to the shoppers.

If a user clicks on a promotions button on the UI shown on the user's computing device, the server can transmit promotions that can match the location and interests of the user. In this example, the system can post the title “top 100 products” and list a plurality of screened offers. The offers can include basic information such as a photo of the goods or services being promoted, the price or discount being offered, the number of products or promotions sold, and a button that can be clicked to accept or get more information about the promotion.

If a user clicks on the promotions button on the UI shown on the user's computing device, the server can transmit more promotion information to the user's computing device. In this example, the left side of the display includes the name of the company, Herbal Sauna and Spa, information about the company, the address, the website and social media information. The main portion of the page can include a photo of the promotion and a written description of the promotion. The user can click on the “buy now” button to accept the promotion. The page can also include a “like” button and a display of the number of people who like the promotion.

In an embodiment, the user's UI may include a “Players” button. When this button is pressed on the UI shown on the user's computing device, the system can display a plurality of player service providers. The players can list their personal and city photos, and list their names, city, country, and player status. The system can also display the ratings of the players. In this example, the ratings are based upon thumbs up or down.

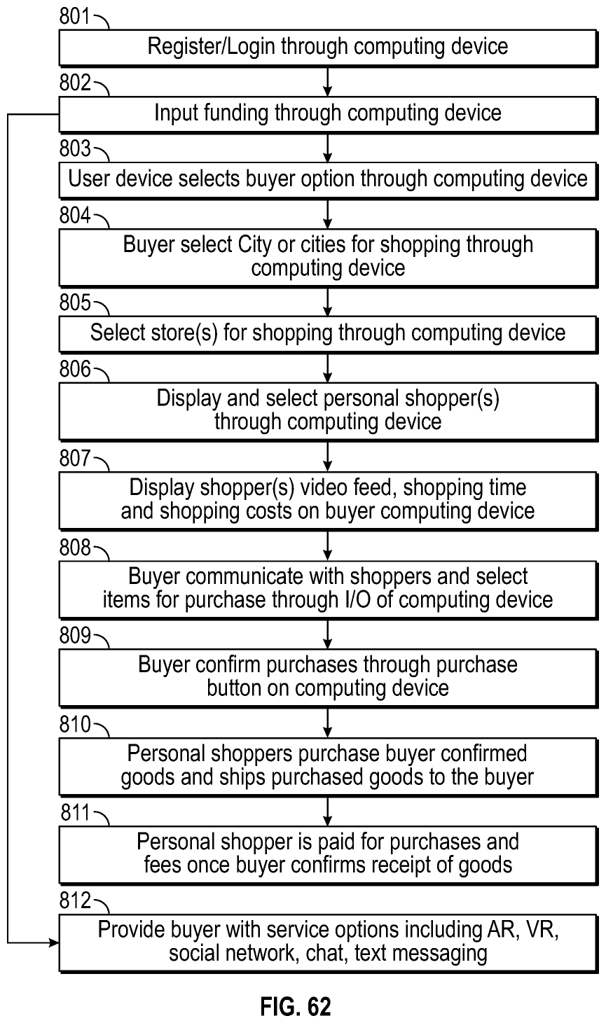

With reference to FIG. 62, a flow chart of the process for a user who decides to be a buyer using the system is illustrated. The UI can first provide a registration or login page which is displayed on the user's computing device 801. The user can select to be a buyer and input funding through the user interface 802. The user interface can also provide the buyer with service options which can include augmented reality, virtual reality, social network, chat and text messaging services 812. The user interface can provide buyer options and the user can select all desired options through the computing device 803. The buyer can select the city or cities for shopping through the UI on the computing device 804. The buyer can select the stores for shopping through the UI of the computing device 805. The system can display and the user can select service provider(s) who can be personal shopper(s) through the UI on the computing device 806. The buyer's computing device can display the personal shopper's video feed on a visual display with the shopping time and shopping costs 807. The buyer can communicate with the personal shopper(s) and select items for purchase through input and output mechanisms on the buyer's computing device 808. The buyer can confirm purchases through a purchase button on the UI of the buyer's computing device 809. The personal shopper can purchase the goods as instructed by the buyer and ship the goods to the buyer 810. The personal shopper is paid for the purchases and the service provider is paid for service fees once the buyer confirms receipt of the goods 811 or delivery of the goods is confirmed by a delivery service.

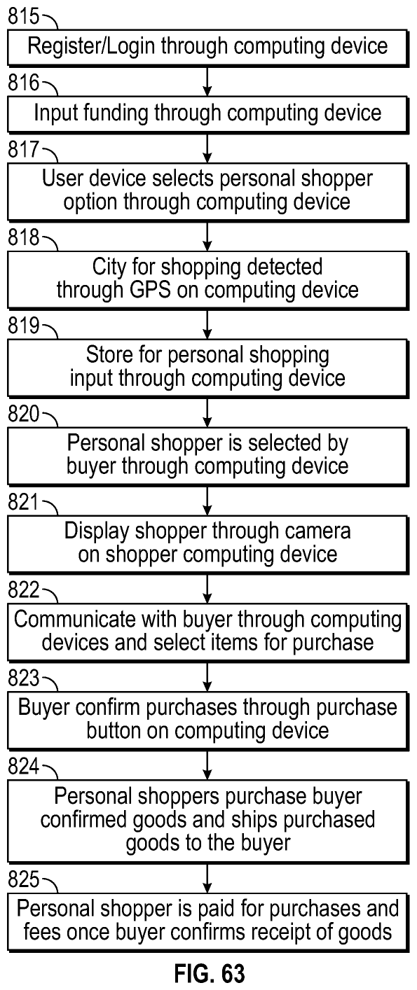

With reference to FIG. 63, a flow chart of the process for a user who decides to be a buyer using the system is illustrated. The UI can first provide a registration or login page which is displayed on the user's computing device 815. The user can select to be a service provider and input funding through the user interface 816. The user interface can input service providers options through computing device 817. The service provider's location city for shopping can be detected by a GPS on the service provider's mobile computing device 818. The service provider's store location for shopping can be detected by a GPS on the service provider's mobile computing device 819. The personal shopper can be selected for personal shopping services by one or more buyers 820. The personal shopper's camera can system can be positioned to show the personal shopper and goods being purchased for the buyer 821. The buyer and personal shopper can communicate through the computing devices to select and purchase goods for the buyer 822. The buyer can confirm the purchases through the buyer UI on the computing device 823. The personal shopper can purchase the goods confirmed by the buyer and ship the purchased goods to the buyer 824. The personal shopper can be paid for the purchases made for the buyers and the service provider fees once the buyer confirms receipt of the goods 825.

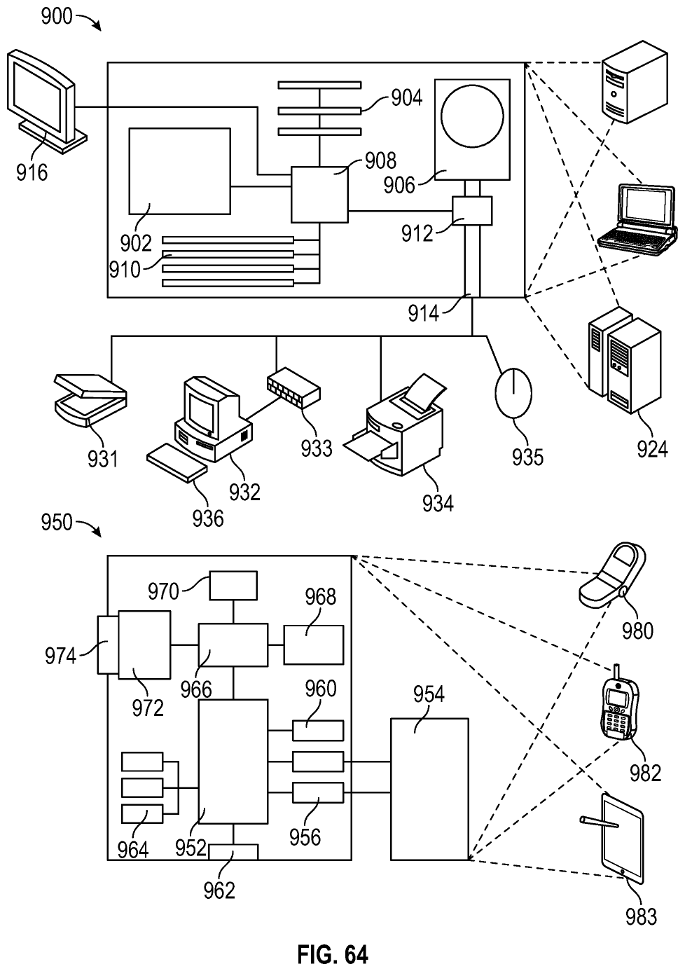

A system FIG. 64 shows an example of a generic computer device 900 and a generic mobile computer device 950, which may be used to implement the processes described herein, including the mobile-side and server-side processes for installing a computer program from a mobile device to a computer. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components processor 902, memory 904, storage device 906, high-speed interface 908, high-speed expansion ports 910, and low speed interface 912 are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple busses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 904, the storage device 906, or memory on processor 902.

The high-speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port 914, which may include various communication ports (e.g., USB, Bluetooth, Ethernet, wireless Ethernet), may be coupled to one or more input/output devices, such as a keyboard 936 in communication with a computer 932, a pointing device 935, a scanner 931, or a networking device 933 such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a Microdrive, solid-state memory or other device, to provide additional storage. Each of the components computing device 950, processor 952, memory 964, display 954, communication interface 966, and transceiver 968 are interconnected using various busses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, memory on processor 952, or a propagated signal that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MIMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, Wi-Fi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, a tablet computer 983 or other similar mobile computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In an embodiment, the described system provides a method for purchasing services comprising providing a server coupled to a database, a buyer computing device, and service provider computing devices. The server can receiving location and on-line status information for the plurality of service provider mobile computing devices. The server can transmit a first description of a service request from the buyer computing device to the server. The server can determine a first group of the plurality of service provider mobile computing devices that provide the service request and have a live status. The server can then transmit a first listing of the first group of the plurality of service provider mobile computing devices that provide the service request and have a live status from the server to the buyer computing devices. A buyer can select one or more service providers from a first plurality of service providers on the first listing by the buyer computing device. Once a serve provider is selected, the service providers can transmit live video data from video cameras on the service provider mobile computing devices of the first plurality of service providers which can be display the first live video data from a first video camera on the service provider mobile computing device that was selected by the buyer computing device. The buyer can authorize through the buyer computing device, the purchase offers for the services from the service provider.

In an embodiment, a second group of service providers can transmit a second description of services request from the buyer computing device to the server. The server can determine a second group of the plurality of service provider mobile computing devices. The server can transmit a second listing of the second group of the plurality of service provider mobile computing devices that provide the second service request to the buyer computing device. The buyer can select a plurality of service providers from the second listing through the buyer computing device. The second service provider(s) can transmit second live video data from video cameras on the service provider mobile computing device of the second service provider that was selected. The live video data from video cameras on the service provider mobile computing device of the second service providers that was selected by the buyer computing device. The live video data from video cameras on the service provider mobile computing devices of the first plurality of service providers and the second plurality of service providers are displayed simultaneously.

In an embodiment, a description of services requests are transmitted from the buyer computing device to the server. The buyer can select a third service provider from the plurality of service providers that provide the third service. The third listing of service provider mobile computing devices are transmitted to the buyer computing device. The buyer can select a service provider from the third listing by the buyer computing device. Live video data is transmitted from video cameras on the service provider mobile computing devices to the buyer's computing device. The live feeds are displayed on the buyer computing device. The live video data can include offers for services from video cameras on the service provider mobile computing devices of the third plurality of service providers that were selected together with the live video data from video cameras on the service provider mobile computing devices of the first plurality of service providers, the second plurality of service providers and the third plurality of service providers which are displayed simultaneously. In an embodiment, the live feed purchasing services are in different locations. The purchasing services process can include receiving by the server, a confirmation of receipt of the services from the buyer computing device and in response, the server can transmit funds to accounts associated with the plurality of service providers that were selected.

In an embodiment, the method for purchasing services which includes the live video data is displayed with buyer controls including at least one of the following controls: buy service, do not buy service, cancel purchase, view shopping cart, view service images, view service description, view product options, view product options, view similar services, view service price history. The live video data displayed on the buyer's computing device can include buyer information including at least one of the following: view account value, add money to account, transfer money to account, insufficient funds notification, stop shopping, prior purchase history, prior purchase status. In an embodiment, the live video data displayed on the buyer's computing device can include service provider information with at least one of the following: service provider photo, service provider rating, service provider message, and service provider purchase history.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The present embodiments are to be considered as illustrative and not restrictive, and the invention is not to be limited to the details given herein. It is therefore intended that the disclosure and following claims be interpreted as covering all such alterations and modifications as fall within the true spirit and scope of the invention.

What is claimed is:

1. A method for purchasing services comprising:
providing a server coupled to a database, a buyer computing device, and service provider mobile computing devices;
receiving location and on-line status information for the plurality of service provider mobile computing devices;
transmitting a first description of services and a first purchase location request from the buyer computing device to the server;
determining a first group of the plurality of service provider mobile computing devices that provide the service request and have a live status;
transmitting a first listing of the first group of the plurality of service provider mobile computing devices that provide the service request from the server to the buyer computing device and have the live status;
selecting a first plurality of service providers from the first listing by the buyer computing device;
transmitting first live video data from video cameras on the service provider mobile computing devices of the first plurality of service providers to the buyer computing device;
displaying by the buyer computing device, the first live video data with first augmented reality video information that includes offers for services from video cameras on the service provider mobile computing devices of the plurality of service providers that were selected;
authorizing by the buyer computing device, the purchase offers for the services from each of the plurality of service providers; and
purchasing the services each of the plurality of service providers.

2. The method for purchasing services of claim 1 further comprising:
transmitting a second description of services request from the buyer computing device to the server;
determining a second group of the plurality of service provider mobile computing devices that are at the second purchase location request;
transmitting a second listing of the second group of the plurality of service provider mobile computing devices that are at the second purchase location request from the server to the buyer computing device;
selecting a plurality of service providers from the second listing by the buyer computing device;
transmitting second live video data from video cameras on the service provider mobile computing devices of the second plurality of service providers;
displaying by the buyer computing device, the second live video data that includes offers for services from video cameras on the service provider mobile computing devices of the second plurality of service providers that were selected;
wherein the first live video data and the second live video data are displayed simultaneously.

3. The method for purchasing services of claim 1 further comprising:
transmitting a third description of services from the buyer computing device to the server;
determining a third group of the plurality of service provider mobile computing devices that provide the third service request;
transmitting a third listing of the second group of the plurality of service provider mobile computing devices that provide the third service request from the server to the buyer computing device;
selecting a plurality of service providers from the third listing by the buyer computing device;
transmitting live video data from video cameras on the service provider mobile computing devices of the third plurality of service providers;
displaying by the buyer computing device, the live video data that includes offers for services from video cameras on the service provider mobile computing devices of the third plurality of service providers that were selected;
wherein the live video data from video cameras on the service provider mobile computing devices of the first plurality of service providers, the second plurality of service providers and the first plurality of service providers are displayed simultaneously.

4. The method for purchasing services of claim 1 further comprising:
receiving by the server confirmation of receipt of the services from the buyer computing device; and
transmitting funds to accounts associated with the plurality of service providers that were selected.

5. The method for purchasing services of claim 1 wherein the live video data is displayed with buyer controls including at least one of the following controls: buy services, do not buy services, cancel purchase, view shopping cart, view services images, view services description, view services options, view service options, view similar services, view service price history.

6. The method for purchasing services of claim 1 wherein the live video data is displayed with buyer information including at least one of the following: view account value, add money to account, transfer money to account, insufficient funds notification, stop shopping, prior purchase history, prior purchase status,

7. The method for purchasing services of claim 1 wherein the live video data is displayed with service provider information including at least one of the following: service provider photo, service provider rating, service provider message, service provider purchase history, and service provider location.

8. A method for purchasing services comprising:
providing a server coupled to a database, a plurality of buyer computing devices, and a service provider mobile computing device;
transmitting a purchase location from the service provider mobile computing device to the server;
receiving purchase requests from the plurality of buyer computing devices by the service provider mobile computing device;
transmitting live video data from a video camera on the service provider mobile computing device to the plurality of buyer computing devices;
displaying by the plurality of buyer computing devices, the live video data that includes offers for services from a video camera on the service provider mobile computing device;
authorizing by the plurality of buyer computing devices, the purchase offers for the services from the service provider computing device; and
receiving a service from the service provider through the buyer computing device.

9. The method for purchasing services of claim 8 further comprising:
receiving by the server confirmation of receipt of the services from the buyer computing device; and
transmitting funds to accounts associated with the plurality of service providers that were selected.

10. The method for purchasing services of claim 8 wherein the live video data is displayed with buyer controls including at least one of the following controls: buy service, do not buy service, cancel purchase, view shopping cart, view service images, view service description, view service options, view service options, view similar service being offered, view service price history.

11. The method for purchasing services of claim 8 wherein the live video data is displayed with buyer information including at least one of the following: view account value, add money to account, transfer money to account, insufficient funds notification, stop shopping, prior purchase history, prior purchase status,

12. The method for purchasing services of claim 8 wherein the live video data is displayed with service provider information including at least one of the following: service provider photo, service provider rating, service provider message, service provider purchase history, service provider location,
